(19) United States
(12) Patent Application Publication
(10) Pub. No.: US 2018/0165626 A1
(43) Pub. Date: Jun. 14, 2018

(54) MERCHANDISING COMMUNICATION AND STOCK-OUT CONDITION MONITORING SYSTEM

(71) Applicant: Cloverleaf Media, LLC, San Diego, CA (US)

(72) Inventors: Gordon Davidson, San Diego, CA (US); Adrian Caminos, San Diego, CA (US); James Welty, San Diego, CA (US); Samuel Chen, San Diego, CA (US); Soul Kounlavong, San Diego, CA (US); Phong Nguyen, San Diego, CA (US)

(21) Appl. No.: 15/821,449

(22) Filed: Nov. 22, 2017

Related U.S. Application Data
(63) Continuation-in-part of application No. 14/815,760, filed on Jul. 31, 2015.
(60) Provisional application No. 62/428,289, filed on Nov. 30, 2016.
(60) Provisional application No. 62/031,258, filed on Jul. 31, 2014.
(60) Provisional application No. 62/190,580, filed on Jul. 9, 2015.

(51) Int. Cl. G06Q 10/08; A47F 5/00; H05B 33/08; H04W 4/35

(52) U.S. Cl. CPC G06Q 10/087; H04W 4/35; H05B 33/0842; A47F 5/0043

(57) ABSTRACT

A system and method for stock-out detection in a retail environment. The method includes sending, from a reference ultrasound emitter, a reference ultrasound pulse that is at least partially reflected by a retail shelf so as to form a return pulse. The return pulse is received at a reference ultrasound receiver. A reference round-trip-delay (RTD) corresponding to a time period between the sending of the reference pulse and the receiving of the return pulse is determined. A monitoring ultrasound pulse is sent toward the retail shelf and a reflection of the monitoring ultrasound pulse is received. A stock-out condition is determined based upon a comparison of the reference RTD and a monitored RTD associated with the monitoring ultrasound pulse.

### CROSS-REFERENCE TO RELATED APPLICATIONS

The present application claims the benefit of priority under 35 U.S.C. § 119(e) of U.S. Provisional Application Ser. No. 62/428,289, entitled MERCHANDISING COMMUNICATION AND STOCK-OUT CONDITION MONITORING SYSTEM, filed Nov. 30, 2016, and is a continuation-in-part of application Ser. No. 14/815,760, entitled MERCHANDISING COMMUNICATION AND INVENTORYING SYSTEM, which claims the benefit of U.S. Provisional Application Nos. 62/031,258, filed 31 Jul. 2014, and 62/190,580, filed 9 Jul. 2015, all of which are incorporated by reference herein in their entireties.

### FIELD

The disclosure relates to merchandising communication systems and to systems and methods for monitoring conditions in various environments, particularly retail environments.

### BACKGROUND OF THE INVENTION

There are a variety of retail options for displaying a variety of information in retail environments, including, pricing, labeling, promotions, etc. Traditionally, this information has been provided using print systems, including slide-in paper system, plastic label systems, adhesive label systems, etc. More recently, there has been increased interest in utilizing digital or electronic systems to display such information.

It is conceivable that off-the-shelf high definition display technology could be used in such applications. Unfortunately, however, the available form factors associated with this technology (16:9, 4:3 and the like) tend to result in units that are bulky, expensive, and require significant power, limiting their scope of commercial adoption. For example, many retail outlets have large numbers of shelves that require the display of information. Certain systems utilize only a single display strip per aisle for displaying the prices of products on a multiple shelves. This approach may alleviate some of the cost-prohibitive nature of such devices, but leaves a great deal to be desired as the prices are no longer located adjacent the product, resulting in frustrated customers having to search for prices. In addition, such systems utilize displays that are not only expensive to install, but to replace. For example, certain proposed displays protrude into the aisles where customers can knock the displays off and/or otherwise damage the displays.

The utilization of less complex and cheaper displays have also been considered, including e-paper displays (EPD), and certain thin-film-transistor liquid crystal displays (TFT LCD). However, such solutions are not one continuous strip. Therefore, a retailer cannot manage and communicate with an entire shelf display or multiple shelf displays in a single action. Instead, such digital and print displays, while possibly being adequate for displaying pricing information, product information, etc., they must be managed individually and do not have the ability to display complete aisle cross-branding, customer communication, display true or full-spectrum color, or full motion video and/or animation.

Another problem confronting retailers is managing “stock-out” conditions existing when a given product is not present on a shelf for the consumer to purchase. In such cases potential sales are lost because the desired product is not on the shelf available for purchase at the appropriate time. This is unfortunately the result even if there is suitable inventory in the back room of the applicable retail establishment or in a nearby warehouse. In some instances, the consumer may abandon the entire shopping trip when a given item is unavailable and move to another retailer to conduct their shopping. When this occurs not only is a sale lost for a particular product, but also potentially for other items the consumer may have intended to purchase on the same trip. Research findings show that a typical retailer loses about 4 percent of sales due to having items out-of-stock.

### SUMMARY

Provided herein is a retail display and stock-out detection system and method. The system includes a display unit comprising a viewable display surface and being attached to a retail shelving assembly. At least one ultrasound emitter/receiver pair is configured to emit ultrasound signals toward a shelf of the retail shelving assembly and to receive reflections of the ultrasound signals. A controller unit is in communication with the display unit and the ultrasound emitter/receiver pair. The ultrasound emitter/receiver pair is further configured to provide an output signal to the controller unit wherein the output signal conveys round-trip-delay (RTD) information associated with the emitted ultrasound signals and the received reflections. The sensor controller includes an input configured to receive the output signal and one or more processors configured to execute controller program modules. The controller program modules are configured to determine a monitored RTD associated with one or more of the ultrasound signals and to determine a stock-out condition based upon a comparison of a reference RTD and the monitored RTD. The reference RTD may, for example, be with respect to a portion of the retail shelf lacking any product items or with respect to a fully stocked portion of the retail shelf.

In one aspect the disclosure relates to a method for stock-out detection in a retail environment. The method includes sending, from a reference ultrasound emitter, a reference ultrasound pulse that is at least partially reflected by one or more product items on a retail shelf, thereby forming a return pulse. The method further includes receiving, at a reference ultrasound receiver, the return pulse and determining a reference round-trip-delay (RTD) corresponding to a time period between the sending of the reference pulse and the receiving of the return pulse. A monitoring ultrasound pulse is also sent toward the retail shelf and one or more reflections of the monitoring ultrasound pulse are received. A stock-out condition is then determined based upon a comparison of the reference RTD and a monitored RTD associated with the monitoring ultrasound pulse.

In another aspect the disclosure pertains to an alternate method for stock-out detection in a retail environment. The method includes sending, from a reference ultrasound emitter, a reference ultrasound pulse that is at least partially reflected by a retail shelf so as to form a return pulse. The method further includes receiving, at a reference ultrasound receiver, the return pulse and determining a reference round-trip-delay (RTD) corresponding to a time period between the sending of the reference pulse and the receiving of the return pulse. A monitoring ultrasound pulse is sent toward the retail shelf and one or more reflections of the monitoring ultrasound pulse are received. A stock-out condition is determined based upon a comparison of the reference RTD and a monitored RTD associated with the monitoring ultrasound pulse.

Also described herein is a display system (e.g., dynamic retail display system) comprising a sensor (e.g., an inventorying sensor (e.g., camera, RFID sensor, a sensor film (e.g., a pressure sensor film, a resistive sensor film, a capacitive sensor film, or the like), etc.) (e.g., the system being configured to use sensor signals to identify product location and/or product inventory), environmental sensor(s)—e.g., humidity sensor, temperature sensor, etc.—and combinations thereof) and one or more display unit (e.g., a display unit or strip described herein). In specific instances, the system or display unit comprises a sensor (e.g., a display unit of the system comprising the camera integrated therein) and a display surface (e.g., both of which are, in exemplary embodiments, combined into a display unit). In some embodiments, the display surface (e.g., LED or LCD array) is configured to face in a first direction and a camera (e.g., lens thereof) is configured to face in a second direction (e.g., a direction about 90 degrees to 180 degrees or about 135 degrees to about 180 degrees opposed to the first direction). In certain embodiments, the sensor is configured to provide output signals to a controller, the sensor output signals conveying information regarding objects (e.g., retail products) configured in proximity to (e.g., within about 10 feet, within about 5 feet, or within about 3 feet, such as behind, below, and/or behind) the display unit (e.g., on a shelf behind, or behind and below, the display unit). In more specific instances, the system comprises a first display unit comprising a first display surface (e.g., an LED or LCD array described herein) and a first camera, the first display surface configured to face a first direction and the first camera configured to face in a second (e.g., opposed) direction; and a second display surface (e.g., an LED or LCD array described herein) and a second camera, the second display surface configured to face a third direction and the second camera configured to face in a fourth (e.g., opposed) direction. In some instances, the first and third directions are the same or different, and the second and fourth directions are the same or different. As used herein, a camera refers to any device suitable for capturing images and/or video.

In certain embodiments, the controller comprises a module configured to identify objects in proximity to a sensor (e.g., camera, RFID sensor, a sensor film (e.g., a pressure sensor film, a resistive sensor film, a capacitive sensor film, or the like), or the like) or display unit of the system (e.g., products or merchandise located on the shelf to which the display unit is attached and/or the products located on a shelf below the shelf to which the display unit is attached). In specific embodiments, the controller comprises a module configured to identify whether or not a misplaced or an out of place object is in proximity to a sensor or display unit of the system. In certain embodiments, the controller comprises a module configured to access a data store comprising information regarding an object assigned to be in proximity to the sensor (e.g., camera) or display unit and a module configured to determine whether or not an object in proximity to the sensor (e.g., camera) or display unit corresponds to the object assigned to be in proximity to the sensor (e.g., camera) or display unit, based on the information conveyed to the controller by the sensor (e.g., camera) output signal (e.g., by comparing an image of an object captured by the camera and conveyed via the output signal to the controller to an image of an object assigned to be in proximity to the camera—such image being stored, e.g., in a data store, and accessed by a controller module). In specific embodiments, the controller comprises a sensor identification module configured to identify the sensor from which the sensor information is conveyed, a module configured to access a data store comprising information associating an object (e.g., a product) with the identified sensor (e.g., camera), and a module configured to determine whether or not an object in proximity to the sensor (e.g., camera) corresponds to the object assigned to be in proximity to the camera. In some embodiments, the controller further comprises a module configured to send an alert output signal to display or otherwise trigger an alert if an unassigned object is identified as being in proximity to the sensor (e.g., camera). In some embodiments, the alert is optionally displayed on a display unit described herein, or on a separate user interface, such as a person computer, tablet, or the like.

In some embodiments, the controller comprises a module configured to determine (e.g., qualitatively or quantitatively) the amount of an object (e.g., product or merchandise) in proximity to a sensor (e.g., camera) of the system (e.g., products or merchandise located on the shelf to which the display unit is attached and/or the products located on a shelf below the shelf to which the display unit is attached), e.g., based on the information conveyed in the sensor output signal (e.g., by comparing an image of an object captured by the camera and conveyed via the output signal to the controller to an image of an object assigned to be in proximity to the camera—such image being stored, e.g., in a data store, and accessed by a controller module—and determining the number of such objects are present in the captured image). In specific embodiments, the controller comprises a module configured to count (i.e., qualitatively determine) the number of objects in proximity to a sensor (e.g., camera) of the system (e.g., using spatial recognition software). In certain embodiments, the controller comprises a module configured to access a data store comprising information regarding an object (e.g., product or merchandise) assigned to be in proximity to the sensor (e.g., camera) and a module configured to determine the amount of the object (e.g., product or merchandise) in proximity to the sensor (e.g., camera), e.g., based on the information conveyed to the controller by the sensor output signal. In specific embodiments, the controller comprises a sensor identification module configured to identify the sensor from which the sensor information is conveyed, and a module configured to access a data store comprising information associating an object (e.g. product or merchandise) with the identified sensor (e.g., camera), and a module configured to determine the amount of the object in proximity to the sensor (e.g., camera). In some embodiments, the controller further comprises a module configured to compare the amount of the object in proximity to the sensor (e.g., camera) to a predetermined parameter (e.g., a value or range, such as a minimum value). In some embodiments, the controller further comprises a module configured to send an alert output signal (e.g., to a display, a light, an audio receiver, a personal computer, a database, or the like) if the amount of the object meets or fails to meet a predetermined parameter (e.g., falls below a minimum value, such as to facilitate re-ordering and/or re-stocking). In some embodiments, the alert is optionally displayed or otherwise signaled on a display unit described herein, on a separate user interface, such as a person computer, tablet, or the like, an alert light (e.g., an LED), a speaker (e.g., for audio alerts), or the like. In certain embodiments, the controller comprises a module configured to record the amount of object in proximity to the sensor (e.g., periodically, such as daily) to a data store (e.g., so as to allow inventory tracking of a product—in some instances, the controller further comprises a module configured to track inventory of a product).

In certain embodiments, a sensor in the form of a rear-facing camera is configured to provide output signals, the output signals conveying information regarding a state of an operating parameter (e.g., an inventory level and/or product or merchandise placement). In certain embodiments, the sensor conveys information suitable for determining inventory levels using, e.g., spatial recognition software, and/or product identification using, e.g., label and/or barcode recognition software, or other desired information. In specific embodiments, the sensor (e.g., camera) is configured to detect (or convey information about) product or merchandise in proximity to the sensor (e.g., camera) (e.g., on a shelf below and behind a unit housing the camera, on a shelf to which a unit housing a camera is affixed or otherwise attached, or the like). Further, in some embodiments, the display unit, e.g., sensor (e.g., camera) thereof, comprises a module configured to store and/or determine a sensor (e.g., camera) identifier associated with (e.g., the location of) the sensor (e.g., camera) (e.g., in and/or near which display units the sensor is located). In specific instances, the sensor identifier is a dynamic identifier, such as an identifier assigned based on the order in which multiple sensors (e.g., cameras) of the system are manually connected to the system

In certain embodiments, a system or display unit (e.g., strip) provided herein further comprises an additional sensor, the additional sensor configured to provide sensor output signals, the sensor output signals conveying information regarding a state of an operating parameter (e.g., of the display unit or sensor). In certain embodiments, the sensor is a motion detector, a camera (e.g., configured to detect motion and/or facial features—i.e., facial recognition), or any suitable sensor for detecting an object or person in proximity to the display, and/or detecting a state of an object or person in proximity to the display. In specific embodiments, the sensor is configured to detect a person located in front of the display and/or in front of closely adjacent displays (e.g., wherein a system comprising multiple display units is provided). In some embodiments, the sensor is configured to detect a predetermined state of a person located in front of the display and/or in front of closely adjacent displays (e.g., wherein a system comprising multiple display units is provided). In specific embodiments, provided herein is a system comprising multiple display units, at least one display unit comprising a sensor. Further, in some embodiments, the display unit, e.g., sensor thereof, comprises a module configured to store and/or determine a sensor identifier associated with (e.g., the location of) the sensor (e.g., in and/or near which display units the sensor is located). In specific instances, the sensor identifier is a dynamic identifier, such as an identifier assigned based on the order in which multiple sensors of the system are manually connected to the system.

In specific instances, the additional sensor is a camera (e.g., wherein a display unit of the system comprising the camera integrated therein) configured to detect the presence of persons and/or objects in proximity to a display surface (e.g., the camera and the display surface both being, in exemplary embodiments, combined into a display unit). In some embodiments, the display surface (e.g., LED or LCD array) is configured to face in a first direction and the camera (e.g., lens thereof) is configured to face in a second direction (e.g., the first and second direction being the same, or being within 0 degrees to about 75 degrees of one another). In certain embodiments, the camera is configured to provide output signals to a controller, the output signals conveying information regarding objects and/or persons configured in proximity to (e.g., in front of) the display unit (e.g., in an aisle in front of—including, e.g., directly in front of and adjacently in front of, and the like). In more specific instances, the system comprises a first display unit comprising a first display surface (e.g., an LED or LCD array described herein) and a first camera, the first display surface configured to face a first direction and the first camera configured to face in a second (e.g., similar) direction; and a second display surface (e.g., an LED or LCD array described herein) and a second camera, the second display surface configured to face a third direction and the second camera configured to face in a fourth (e.g., similar) direction. In some instances, the first and third directions are the same or different, and the second and fourth directions are the same or different. In specific instances, the system comprises a sensor configured to provide output signals to a controller, the output signals conveying information regarding the state of an operating parameter, the controller configured to identify the state of an operating parameter (e.g., identify the status of a predetermined sensor state, such as motion, no motion, and captive (e.g., as determined by identification of a face using face detection software)) and to provide predetermined display information (content) to the one or more display units of the system based on the identified sensor state.

In some embodiments, provided herein is a system (e.g., a retail display system) comprising any display described herein, camera (e.g., rear facing camera), an optional additional sensor (e.g., forward facing camera), and a controller. In various embodiments, the controller comprises one or more controller units that when taken together comprise the features and/or perform the functions described herein. In some embodiments, the controller comprises an output configured to provide global system display information to one or more display units (e.g., multiple display units). In certain embodiments, the controller comprises an input configured to receive a sensor output signal (e.g., from one or more sensor (e.g., a forward facing and/or rear facing camera) of one or more display units described herein).

In some embodiments, the system, e.g., controller thereof, comprises a sensor state identification module configured to identify or monitor a sensor state (e.g., of an operating parameter) of a sensor thereof (e.g., configured to detect sensor states and/or interactions). For example, in certain embodiments, the sensor state identification module is configured to detect whether or not a person is in proximity to a display unit of the system (e.g., the display unit in which the sensor is located, or an adjacent or otherwise nearby display unit) (e.g., wherein the sensor state operating parameter is near or not near one or more display unit of a system described herein). In further or additional embodiments, the sensor state identification module is configured to detect whether or not an inventory level of a product is low (e.g., below a predetermined level) or high (e.g., above a predetermined level) and/or whether or not a product is misplaced. In some embodiments, a system provided herein further comprises a sensor state information module configured to identify predetermined information to be provided to (or displayed on) a display unit based on whether or not a predetermined sensor state (e.g., of an operating parameter) of a sensor has been satisfied.

In specific embodiments, provided herein is a display system comprising a first camera, a second camera and one or more display unit. In specific embodiments, the display unit comprises the first camera, the second camera (or other sensor configured to detect persons or evidence of persons (e.g., motion, heat, or the like), such as customers, in front of or in viewable proximity of the display surface), and a display surface (e.g., the display surface comprising an LED or LCD array described herein). In some embodiments, the display surface (e.g., LED or LCD array) is configured to face a first direction, the first camera (e.g., lens thereof) is configured to face a second direction (e.g., a direction about 90 degrees to 180 degrees or about 135 degrees to about 180 degrees opposed to the first direction—a rear facing direction), and the second camera (e.g., lens thereof) is configured to face a third direction (e.g., a direction 0 degrees to about 90 degrees or 0 degrees to about 75 degrees or about 0 to about 45 degrees of the first direction—a forward facing direction). In certain embodiments, the first camera is configured to provide first output signals to a first controller, the first output signals conveying information regarding objects (e.g., retail products) configured in proximity to (e.g., behind, below, and/or behind) the display unit (e.g., on a shelf behind, or behind and below, the display unit), and the second camera is configured to provide second output signals to a second controller (e.g., a sub-controller unit of the system controller), the second output signals conveying information regarding the state of an operating parameter. Further, in specific embodiments, the second controller is configured to identify the state of an operating parameter (e.g., identify the status of a predetermined sensor state, such as motion, no motion, and captive (e.g., as determined by identification of a face using face detection software)) and to provide predetermined display information (content) to the display unit based on the identified state of the operating parameter. In further embodiments, the system further comprises an environmental sensor (e.g., a temperature sensor, a humidity sensor, or both). In specific embodiments, the environmental sensor is configured to provide environmental sensor output signals to a third controller (e.g., a sub-controller unit of the system controller). In some embodiments, the third controller comprising a module configured to determine an environmental state in proximity to the sensor (e.g., in proximity to a display unit of the system). In various embodiments, the first, second, and third controllers are optionally taken together in a single device (e.g., a single computer or control unit), or in any combination of devices.

In some embodiments, provided herein is a display system (e.g., a retail display system) comprising a first display unit and a second display unit, the first display unit comprising a display surface (e.g., an LED display surface described herein), a forward facing camera (e.g., facing in a direction within 0 to about 75 degrees of the direction in which the display surface is facing), and a rear facing camera (e.g., facing in a direction of about 90 to about 180 degrees opposed to the direction in which the display surface is facing); and the second display unit comprising a display surface (e.g., an LED display surface described herein), and a rear facing camera (e.g., facing in a direction of about 90 to about 180 degrees opposed to the direction in which the display surface is facing). In specific embodiments, the system comprises at least one first display unit and multiple second display units. In some instances, given the open configuration in front of a display unit, a single forward facing or forward detecting sensor (e.g., camera) is able to be configured to detect the state of an operating parameter (e.g., for determining target—customer—proximity) for several display units, whereas the rear facing sensors (e.g., cameras) are situated closely to the objects (e.g., shelved merchandise behind the display units), affording them less field of view. Therefore, in some instances, it is desirable to reduce the number of forward detecting sensors in a system provided herein in order to further enhance affordability of the system. In some embodiments, a system provided herein comprises at least 2 rear facing sensors to every 1 forward detecting sensor. In more specific embodiments, the ratio is at least 4:1 or at least 8:1.

Provided in certain embodiments herein is a display unit, such as a high aspect ratio display strip. In specific embodiments, such display units are configured for use in a retail environment, such as being configured to be affixed to or integrated with a retail shelving system. In other embodiments, high aspect ratio display strips provided herein are optionally configured to be utilized in other applications, including being configured to be affixed to or integrated with non-retail shelving systems.

In some embodiments, provided herein is a shelf display unit (e.g., LED or LCD display strip). Generally, the shelf display unit comprises an array of viewable LED or LCD pixels, and an input configured to receive (or be connected to receive) display information. In some instances, the input is configured to receive display information from a controller, e.g., directly from the controller, via another shelf display unit (e.g., by daisy chaining there through), or the like. In some embodiments, the display information is global system display information, such as display information for multiple display units—e.g., multiple display units connected to a common controller. In some embodiments, the display unit further comprises a display component output configured to provide display information to the array of viewable LED or LCD pixels (e.g., or an shelf display component body, the shelf display component being the component body, such as a circuit board, of the unit comprising the array of LED pixels mounted or embedded therein/thereon, or LCD sub-assembly attached to the circuit board). In specific embodiments, the display information provided to the LED or LCD pixel array is the display information received by the display unit, or a subset thereof. In specific embodiments, such as wherein multiple display units are controlled by a controller, the shelf display unit is configured to receive global system display information and provide local display information (a subset of the global system display information) to the LED or LCD pixel array. In further embodiments, a display unit provided herein comprises one or more processors (e.g., a FPGA) configured to execute one or more program modules. An exemplary program module comprises, by way of non-limiting example, a content identification module configured to identify the local display information (e.g., identify the subset of global system display information that is to be displayed on the specific display unit). Additional non-limiting, exemplary display unit program modules that are optionally included in the display units provided herein are found throughout this disclosure.

Any suitable depth of display unit (e.g., strip) is optionally utilized. In preferred embodiments, the depth of the display strip is small enough to limit its protrusion into an aisle and to reduce risk of aisle traffic bumping into the strip and potentially damaging it. The LED or LCD displays and systems provided herein allow for low profile (i.e., low depth) displays to be provided, without losing their cost effectiveness. In some embodiments, the depth of the display is less than 50 mm, e.g., less than 30 mm. In still more preferred embodiments, the depth of the display is less than 25 mm. In yet more preferred embodiments, the depth of the display is less than 20 mm. In certain instances, displays have a preferred depth of about 10 mm to about 25 mm, e.g., about 15 mm to about 20 mm.

In some embodiments, provided herein are LED displays (e.g., a component of a display unit or strip described herein) comprising an array of viewable LED pixels. In further embodiments, provided herein are systems and display units or strips comprising one or more such LED display (also referred to herein as an LED display component). In specific embodiments, the LED pixel comprises a red light emitting diode, a green light emitting diode, or a blue light emitting diode. In more specific embodiments, the LED pixel comprises a red light emitting diode, a green light emitting diode, and a blue light emitting diode. In certain embodiments, the light emitting diode is a light emitting diode chip. In specific embodiments, the LED display component comprising a conductive substrate (e.g., a printed circuit board (PCB) (e.g., a metal core printed circuit board (MCPCB))) comprising multiple light emitting diode chips mounted on or embedded in a substrate (e.g., using chip on board technologies). The chip is optionally mounted to the substrate using any suitable technique, such as by affixing the chip with an electrically conductive adhesive (e.g., an epoxy, an acrylic, a cyanoacrylate, a silicone, a urethane acrylate, or the like comprising a conductive filler, such as silver, nickel, carbon, or the like) or using any other suitable technique, such as soldering. In some embodiments, it is possible to reduce the pixel pitch (i.e., the distance between the center of one pixel to the center of adjacent pixel(s)). In some embodiments, any suitable LED technology is optionally utilized, e.g., multiple cups chip on board (MCOB), chip on board (COB) LED, surface mounted device (SMD) LED, wired LED, or the like. In preferred embodiments, the pixel pitch of any LED display or display unit provided herein is about 3.0 mm or less. In more preferred embodiments, the pixel pitch is about 2.5 mm or less. In still more preferred embodiments, the pixel pitch is about 2.0 mm or less. In yet more preferred embodiments, the pixel pitch is about 1.9 mm or less (e.g., about 1.875 mm).

In some embodiments, provided herein are LCD displays (e.g., a component of a display unit or strip described herein) comprising an array of viewable LCD pixels. In further embodiments, provided herein are systems and display units or strips comprising one or more such LCD display (also referred to herein as an LCD display component). In specific embodiments, the LCD pixel is part of an enclosed Liquid Crystal Display backlit by LEDs. In some embodiments, it is possible to increase the pixel density (i.e., the number of pixels per square inch of LCD, also referred to as PPI). In preferred embodiments, the pixel pitch of any LCD display or display unit provided herein is about 45 ppi or greater. In more preferred embodiments, the pixel pitch is about 55 ppi or greater.

In certain embodiments, the array of viewable LED pixels has a first number of pixels in the first dimension and a second number of pixels in a second dimension. In some embodiments, the first (height) dimension comprises about 24 pixels or more. In preferred embodiments, the first (height) dimension comprises about 30 pixels or more (e.g., about 32 pixels). In more preferred embodiments, the first (height dimension comprises about 30 to about 60 pixels. Generally, about 30 or more pixels are preferred to provide minimum desired display requirements, providing for at least three lines of text with minimal visible text defect. Any suitable number of pixels is present in the second (length) direction. Pixel pitch in the second (length) dimension is preferably about the same as the pixel pitch in the dimension, the number of pixels being determined thereby and by the length of the display unit. In certain embodiments, the number of LED pixels in the second dimension is about 100 or more. In preferred embodiments, the number of LED pixels in the second dimension is about 100 to about 500, e.g., about 120 to about 200 or about 160.

In certain embodiments, the array of viewable LCD pixels has a first number of pixels in the first dimension and a second number of pixels in a second dimension. In some embodiments, the first (height) dimension comprises about 80 pixels or more. In preferred embodiments, the first (height) dimension comprises about 90 pixels or more (e.g., about 92 pixels). In more preferred embodiments, the first (height dimension comprises about 90 to about 120 pixels. Generally, about 90 or more pixels are preferred to provide minimum desired display requirements, providing for at least ten lines of text with minimal visible text defect. Any suitable number of pixels is present in the second (length) direction. Pixel pitch in the second (length) dimension is preferably about the same as the pixels per inch in the dimension, the number of pixels being determined thereby and by the length of the display unit. In certain embodiments, the number of LCD pixels in the second dimension is about 1000 or more. In preferred embodiments, the number of LCD pixels in the second dimension is about 1000 to about 1500, e.g., about 1200 to about 1300 or about 1280.

In some embodiments, the viewable surface of the LED display component comprises an array of viewable LED pixels and a coating (e.g., a conformal coating in which the LED pixels or components thereof are embedded in the coating). In certain embodiments, the coating comprising any suitable material, such as an epoxy, a polyurethane, an acrylic, a silicone, or a combination thereof. In some embodiments, such coatings serve to protect the LED components from impact damage or environmental damage (e.g., from humidity, mildew, thermal variation, liquid spills, etc.).

In preferred embodiments, the display unit(s) (e.g., strips) comprise at least a first and a second light emitting diode (LED) display component. In certain instances, the use of a first and a second light emitting diode (LED) display component further facilitates cost effective display replacement options, such as when a display component become damaged or otherwise has less than optimal or desired functionality. In such instances, replacement of a display component is optionally effected without replacing the entire display unit or even the entire display portion of the display unit.

In certain embodiments, a display unit (e.g., strip) provided herein comprises an input configured to receive display information (e.g., display information to be displayed on the display unit and, optionally, to be displayed on one or more additional display unit(s)). In some embodiments (e.g., in a system comprising multiple display units), the input is configured to receive global system display information. Generally, global system display information comprises the display information to be displayed on one or more LED display units (and, optionally, additional display types). In some embodiments, the global system display information comprises the display information to be displayed on multiple display units. In certain embodiments, the global system display information is provided to multiple display units in any suitable manner. For example, in some embodiments, the global system display information is directly provided to the inputs of the multiple shelf display units. In other embodiments, the information is provided to the multiple Shelf display units by daisy chaining the information through one or more of the multiple display units.

In some embodiments, a display unit (e.g., strip) provided herein further comprises an output configured to provide display information (e.g., global system display information) to an additional display (e.g., a shelf display unit described herein)—such as in a daisy-chaining manner. In certain embodiments wherein the shelf display unit is present in a multiple display unit system, the output is configured to provide display information (e.g., global system display information) to an input configured to receive display information of a second shelf display unit.

In certain embodiments, a display unit (e.g., strip) comprises an output configured to provide local display information. In certain embodiments, local display information is specific to the display unit. In some embodiments, local display information is a subset of the global system display information. In other embodiments, local display information is specific to a shelf display component. In some embodiments, the output is configured to provide local display information to a shelf display component of the display unit. In specific embodiments, the display unit comprises a first output configured to provide local display information (e.g., first local display information) to a first shelf display component and a second output configured to provide local display information (e.g., second local display information) to a second shelf display component.

In some embodiments, the display unit comprises an identification module (e.g., hardware, software, firmware, or the like) configured to store and/or determine an identifier associated with the display unit, or of display components thereof (e.g., in certain instances wherein a display unit comprises multiple display components). In specific embodiments, the identifier is associated with the location of the display unit within a system comprising the display unit and at least one additional display (e.g., additional display units or strips of the type described herein). In certain embodiments, the identification module identifies the location of the display unit, such as the location in a system comprising multiple display units, including one or more of the shelf display units described herein and, optionally, additional display unit types.

In some embodiments, the display unit(s) comprises a content identification module configured to identify the information (e.g., video, images, text, and/or the like) to be displayed at the identified location. In specific embodiments, the content identification module identifies a subset of information to be decompressed by the de-compression module and displayed at the identified location. In some such embodiments, the de-compression module de-compresses (e.g., only) the subset of information received that is to be displayed at the identified location.

In some embodiments, the display unit (e.g., strip) comprises a content identification module that is configured to identify the local display information (e.g., as-received or de-compressed information) to be displayed on the display unit. In specific embodiments, one or more content identification module is configured to identify local display information to be displayed on a first shelf display component and a second shelf display component. In more specific embodiments, a single content identification module is configured to identify local display information for both a first and a second shelf display component. In other specific embodiments, a first content identification module is configured to identify first local display information for (e.g., to be displayed on) a first shelf display component and a second content identification module is configured to identify second local display information for (e.g., to be displayed on) a second shelf display component.

In some embodiments, the display unit (e.g., strip) comprises an information decompression module that is configured to decompress compressed display information. In specific embodiments, the information decompression module is configured to decompress compressed global system display information, or a subset thereof, received by the display. In specific embodiments, the information decompression module is configured to decompress local display information (e.g., decompress information identified by the content identification module as being local display information for the identified display).

In certain embodiments, modules described herein are program modules, one or more processors configured to execute such program modules. In various embodiments, processors provided herein are units capable of executing and/or configured to execute program modules and include, by way of non-limiting example, computer processing units (CPUs), graphics processing units (GPUs), field-programmable gate arrays (FPGAs), and combinations thereof. In other embodiments, modules are, optionally, hardware modules, firmware modules, or other suitable modules. In various embodiments, modules comprise a combination of program and hardware modules.

### BRIEF DESCRIPTION OF THE DRAWINGS

FIG. 1 illustrates a front perspective view of an exemplary high aspect ratio LED display unit comprising an array of viewable LED pixels.

FIG. 2 illustrates various components of an exemplary display unit provided herein.

FIG. 3 illustrates various components of an exemplary display unit provided herein.

FIG. 4 illustrates an exemplary retail shelving system comprising multiple display units provided herein.

FIG. 5 illustrates an exemplary segmentation schematic of graphic card display configurations into smaller height segments used in the display units and systems provided herein.

FIG. 6 illustrates an exemplary logical layout on one or more shelf face using a segmented graphics card configuration.

FIG. 7 illustrates an exemplary segmented content configuration of an exemplary system provided herein.

FIG. 8 illustrates components and modules of an exemplary system provided herein.

FIG. 9 illustrates components and modules of an exemplary system provided herein.

FIG. 10 illustrates modules of an exemplary controller or system provided herein, or steps of an exemplary method provided herein.

FIG. 11 illustrates modules of an exemplary controller or system provided herein, or steps of an exemplary method provided herein.

FIG. 12 illustrates an exemplary configuration of single sensors detecting multiple sensor states, e.g., in multiple sensor zones.

FIG. 13 illustrates an exemplary depiction of a retail store aisle comprising one or more retail display system provided herein.

FIG. 14 illustrates a rear view of an exemplary display unit provided herein.

FIG. 15 illustrates an exemplary LED or LCD array of a display unit provided herein, with exemplary text configurations for display thereon.

FIG. 16 illustrates an exemplary system comprising a controller and one or more display units.

FIG. 17 an exemplary system or process configured to provide an output signal to a sensor controller, and the optional output results thereof.

FIG. 18 illustrates a cross sectional view of an exemplary display unit provided herein.

FIG. 19 illustrates a cross sectional view of an exemplary shelving system comprising a display unit provided herein.

FIGS. 20A-20F depict arrangements of ultrasound sensors configured to be utilized to detect a “stock-out” condition.

FIG. 21 illustrates an embodiment of a SOAR system in which one sensor within a group of ultrasound sensors associated with a particular portion of a retail shelf is utilized as a reference ultrasound sensor.

FIG. 22 is a schematic diagram of a stock-out alerting and reporting system capable of being deployed on multiple retail shelves.

FIG. 23 illustrates an exemplary retail display and stock-out condition monitoring system comprising a controller and one or more display units.

### DETAILED DESCRIPTION OF THE INVENTION

In certain embodiments, the light emitting diode displays provided herein is a high aspect ratio light emitting diode display strip, systems comprising the same and components thereof. In specific embodiments, the display strips are useful for and/or configured for retail applications, such as to be integrated with or attached to retail scaffold, such as (e.g., the front surface of) a shelf. In specific applications, the shelf is a retail shelf.

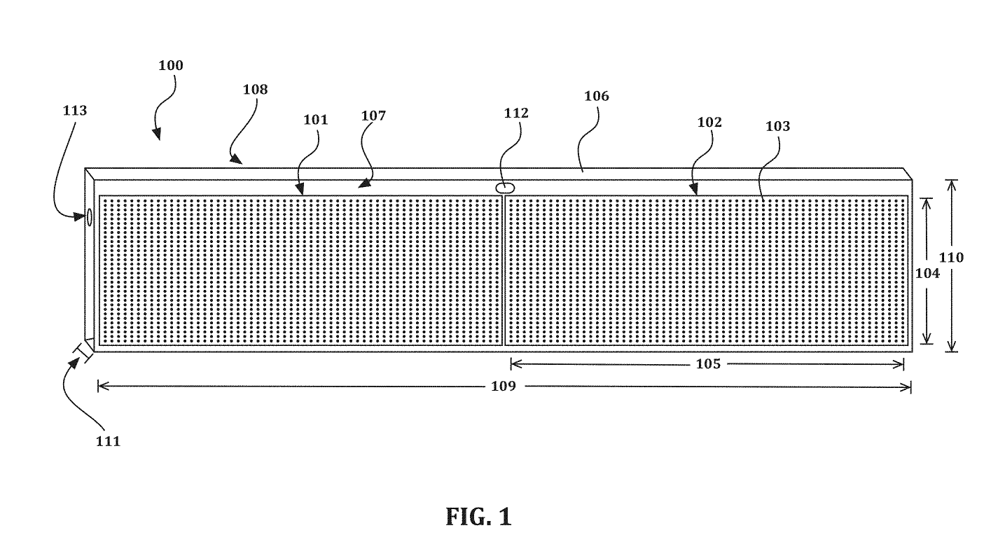

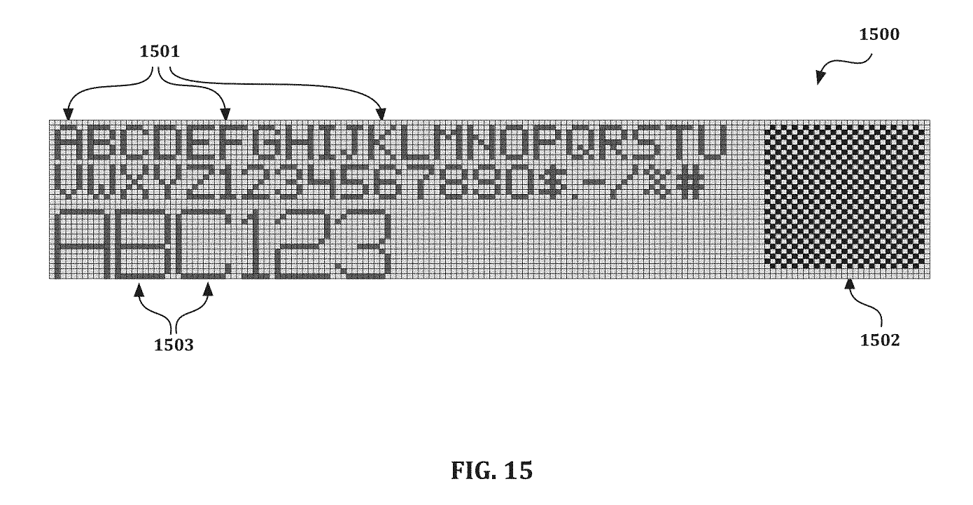

FIG. 1 illustrates an exemplary high aspect ratio shelf display unit 100 provided herein. The exemplary display unit comprises a first shelf display component 101 and a second shelf display component 102. Each exemplary display unit comprises an array of LED pixels 103, the array comprising 32 LED pixels in a first dimension 104 and 80 LED pixels in a second dimension 105, the display unit as a whole comprising an array of 160 LED pixels by 32 LED pixels. In addition, the exemplary display unit comprises a housing body 106, comprising a front surface 107 and rear surface 108 and having a length 109, a height 110, and a depth 111. The front and rear surfaces are optionally flat or contoured, depending on the specific application. The exemplary display unit further comprises a forward facing (e.g., positioned to face outward from the front surface of the) sensor (e.g., motion detector or camera) 112 situated in an approximately central position along the length of the display unit. In some embodiments, the sensor (e.g., camera) is located in a forward facing position on an upper portion of the display unit (e.g., as displayed in FIG. 1), on a lower portion of the display unit (e.g., if the display unit of FIG. 1 were flipped over), or any other suitable position. In exemplary embodiments, the display unit 100 comprises one or more chaining (e.g., daisy-chaining) connectors 113, e.g., configured to receive and/or convey, provide or transmit display information (e.g., to additional display units—not illustrated). FIG. 14 illustrates the rear surface of an exemplary display unit 1400 provided herein. In some instances, the display unit comprises a power input 1401 and a power output 1402 (e.g., a simple two pin power connector, such as Molex), e.g., configured to daisy chain power to one or more additional display unit. In certain instances, the display unit comprises a display information input 1403 and a display information output, e.g., configured to daisy chain data to one or more additional display unit. In some instances, the display unit further comprises one or more data input and/or output 1404 and 1405 (e.g., a USB type output, such as USB 3.0, USB 2.0, mini USB, micro USB, or the like), such as a sensor information output and/or a sensor information input (e.g., configured to receive and/or convey sensor information from one or more sensor). In specific instances, the two data outputs 1404 and 1405 are data outputs for conveying output signals away from the display unit 1400 from the forward sensor 112 and the rear sensor 1408. In some instances, display units provided herein are integrated with a shelving system, or the like, and in other instances, the display units are configured to be capable of being attached to retail scaffold, such as a shelf (e.g., the front edge thereof), e.g., using one or more bracket or magnet 1407.

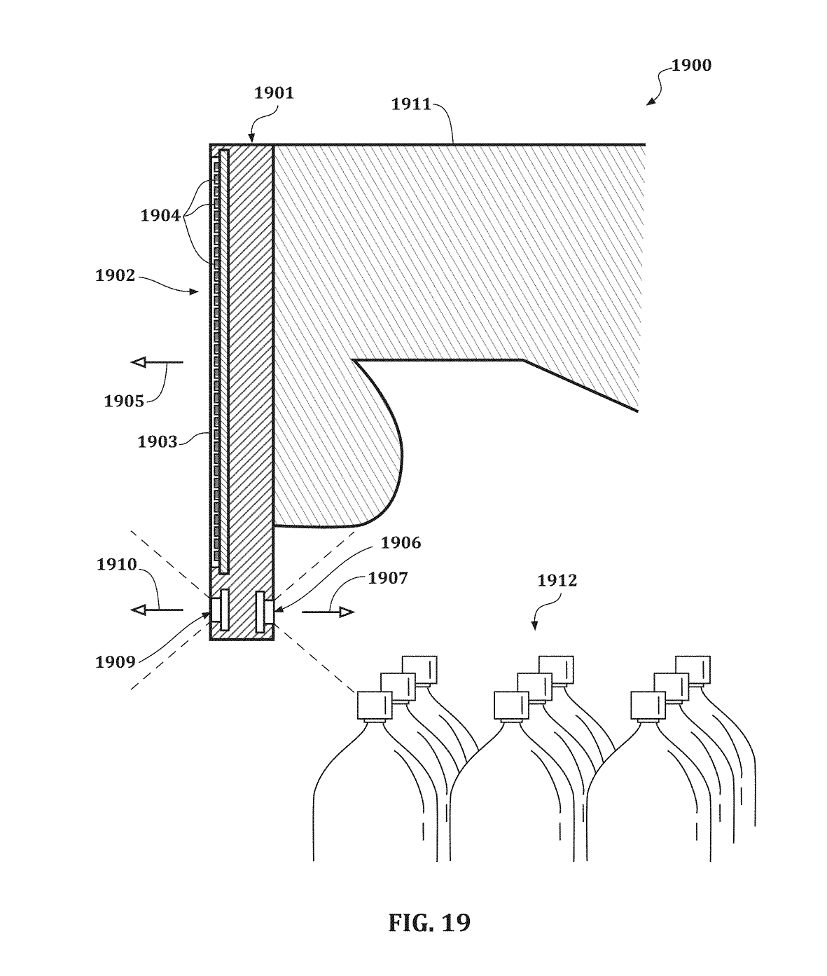

As illustrated in the cross-sectional view of FIG. 18, in some embodiments, a display unit 1800 provided herein comprises a display surface 1801 (e.g., comprising an LED or LCD array, which is optionally coated 1803, such as with a resin to protect the LED pixels 1804) is configured to face in a first direction 1805 and the camera 1806 (e.g., lens thereof) is configured to face in a second direction 1807 (e.g., a direction about 90 degrees to 180 degrees or about 135 degrees to about 180 degrees opposed to the first direction). In specific embodiments, the first and second directions are parallel and opposed (i.e., 180 degrees opposed), such as illustrated in FIG. 18. In some instances, the camera 1806 has an angle of view 1808 (e.g., any suitable angle 180 degrees or less, such as about 120 degrees), the second direction 1807 bisecting the angle of view 1808. In some embodiments, the display unit further comprises a second camera 1809, configured to face in a third direction 1810 (e.g., a direction 0 degrees to about 90 degrees aligned with the first direction). In some instances, the second camera 1809 has an angle of view 1811 (e.g., any suitable angle 180 degrees or less, such as about 60 degrees), the third direction 1810 bisecting the angle of view 1811. In some embodiments, the first direction and third direction are aligned within 0 degrees of each other (i.e., parallel as illustrated in FIG. 18). In other embodiments, the first and third directions are aligned within 90 degrees of one another (e.g., within 60 degrees, within 45 degrees, within 30 degrees, or the like of one another).

In some embodiments, provided herein is a display unit comprising a power supply (e.g., a DC/DC converter or an AC/DC converter). In certain embodiments, a display unit provided herein is configured to receive power and display information via a single source, such as over Ethernet. In other embodiments, a display unit provided herein is configured to receive power and display information via different sources. In some embodiments, display units provided herein further comprise power regulators, e.g., to ensure a stable voltage provided to the display unit components. In some embodiments, display units provided herein additionally comprise one or more LED driver, e.g., configured to control the current provided to the LED or LCD array, which in some instances reduces the risk of LED failure.

Display units provided herein are configured to receive display information from wired and/or wireless sources. In certain embodiments, the display unit(s) (e.g., strip) comprises a receiver for receiving information (e.g., digital information). In various embodiments, the receiver comprises an input, such as a wired information input (e.g., a port) (e.g., a USB (e.g., USB 1.0, USB 2.0, USB 3.0) input, a modular connector input (e.g., 4 position 4 contact (4P4C), 6P6C, 6P2C, 6P4C, 6P6C, 8P8C, 10P10C, or similar modular connector)), an Ethernet input, a cat5 input, a cat5e input, a cat6 input, a micro USB input, a mini USB input, a registered jack (e.g., rj11) input, a component input, a RCA input, a coaxial input, a digital visual interface (DVI) input, a video graphics array (VGA) input,) a wireless information (e.g., Wi-Fi, 4G, 3G) input, or the like. In certain embodiments, the receiving module is configured to receive compressed information.

Further, display units provided herein generally comprise one or more processor configured to execute one or more program module. In specific embodiments, the processor is a field programmable gate array or suitable microprocessor. In some embodiments, the one or more processor is configured to execute an identification module configured to store and/or access a stored identifier associated with the display strip in which the processor is located. In specific embodiments, the identifier is associated with the location of the display strip. In further embodiments, the one or more processor is configured to execute an identification module configured to determine an identifier associated with the display strip in which the processor is located. In certain embodiments, the one or more processor is configured to execute a content identification module configured to identify local display information to be displayed on the display unit in which the processor is located. In some embodiments, the local display information is a subset of global system display information received by the display unit receiver. In certain embodiments, the one or more processor is configured to decompress global system display information or a subset thereof—such as the identified local display information.

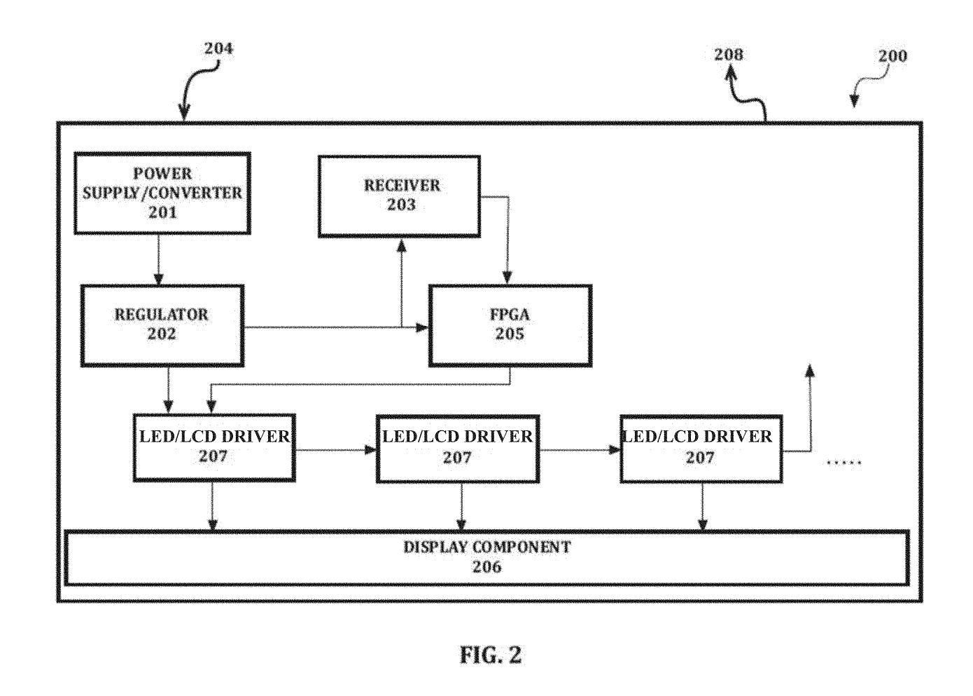

FIG. 2 illustrates an exemplary display unit 200 provided herein, wherein the display unit is configured to receive power and display information over Ethernet (using Ethernet protocols, or using a cat5, cat5e, cat6 or similar Ethernet type cable using other suitable protocols). The display unit comprises an optional power supply or power converter 201 configured to receive integrated display information and power 204, and an optional power regulator 202 configured to provide a suitable power source to the display unit (e.g., various components thereof). In some embodiments, the power supply or power converter is configured to convert received DC voltage to a suitable DC voltage (e.g., about 3 Vdc to about 5 Vdc) and the power regulator is configured to regulate the voltage (e.g., at about 3 Vdc to about 5 Vdc). The exemplary display unit 200 further comprises a display information receiver 203, such as the Ethernet receiver illustrated, and a processor 205, such as the FPGA illustrated. In certain embodiments, the processor 205 is configured to determine the display information to be displayed on the LED or LCD array 206. Optional LED or LCD drivers 207 are also included. Display information and power are optionally provided to additional display units via any suitable technique, such as daisy chaining 208 (e.g., using a T568B Ethernet cable, digital video cable, or any other suitable cable).

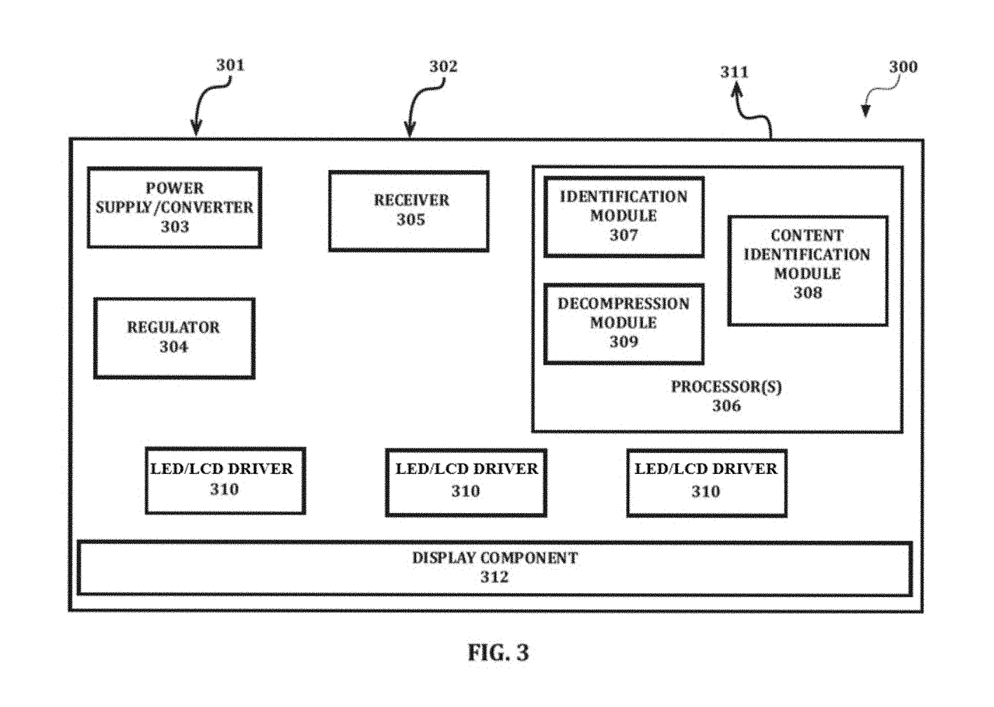

FIG. 3 illustrates another exemplary display unit 300, wherein the display unit is configured to receive power in a first (power) input 301 (e.g., receive AC power) and display information in a second (information) input 302 (e.g., receiving compressed display information). The display unit comprises an optional power supply 303 (e.g., converting AC power to DC power, such as about 3 Vdc to about 5 Vdc) connected to the power input 301, and an optional power regulator 304 connected to the power supply 303 and configured to provide a suitable power source to the display unit (e.g., various components thereof). The information input 302 is connected to a receiver (information receiver) 305. The display unit comprises one or more processors (e.g., FPGA) 306 configured to execute one or more program modules configured to identify local display content to be displayed on the display unit (i.e., the LED or LCD array thereof 312). In some embodiments, the program modules comprise a display identification module 307, a content identification module 308, and a decompression module 309. Optional LED or LCD drivers 310 are also included. Display information and power are optionally provided to additional display units via one or more output 311 using any suitable technique, such as daisy chaining.

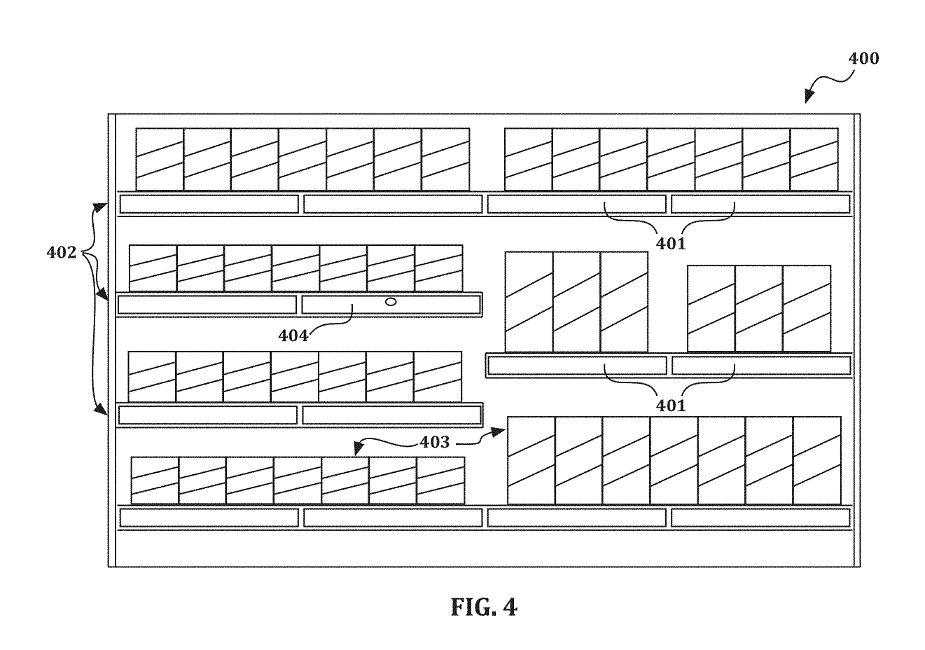

FIG. 4 illustrates a retail system 400 comprising multiple display units 401 provided herein. The display units are optionally affixed to and/or integrated with retail shelving 402. As is illustrated, given the cost effective nature of the displays, it is possible to utilize the display units 401 provided herein to provide specific display content for each product 403 on the shelves, even when the shelves are in complex configurations. In some embodiments, the system comprises one or more display unit comprising a sensor 404 (e.g., camera) configured to detect a sensor state, such as proximity to the sensor or a display unit comprising the sensor, and/or near a display unit comprising the sensor. In some instances, only a single sensor comprising display unit is needed to detect, for example, proximity to several (e.g., nearby) display units. For example, while each or multiple display units of a system optionally comprise a sensor, FIG. 4 illustrates a single display unit comprising a sensor 404. In some embodiments, by reducing the number of display units comprising a sensor, an even more cost effective system is achieved.

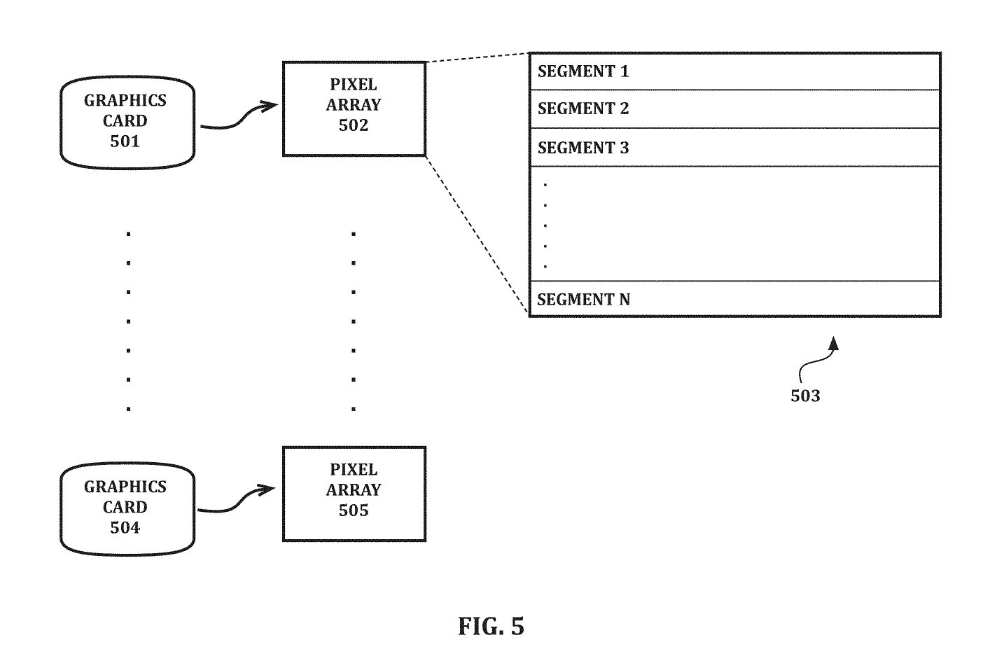

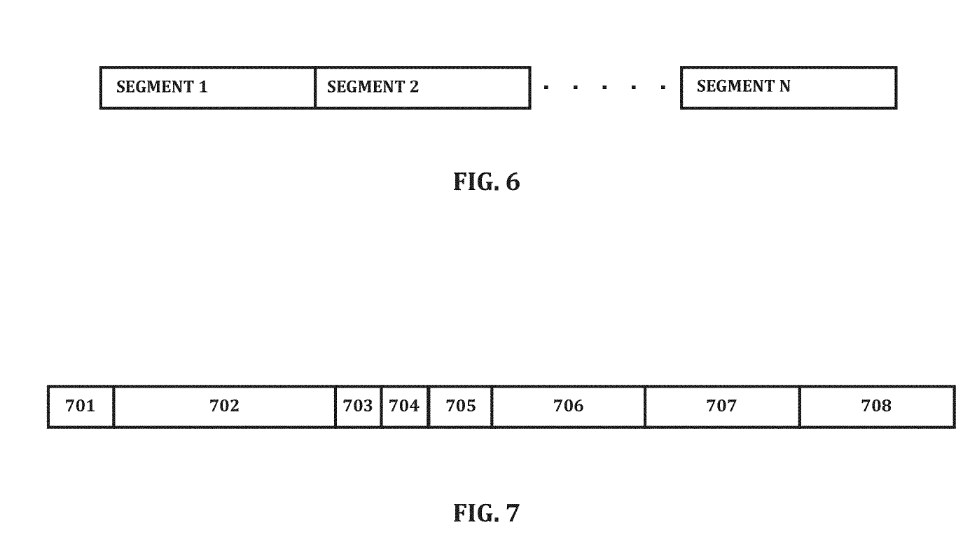

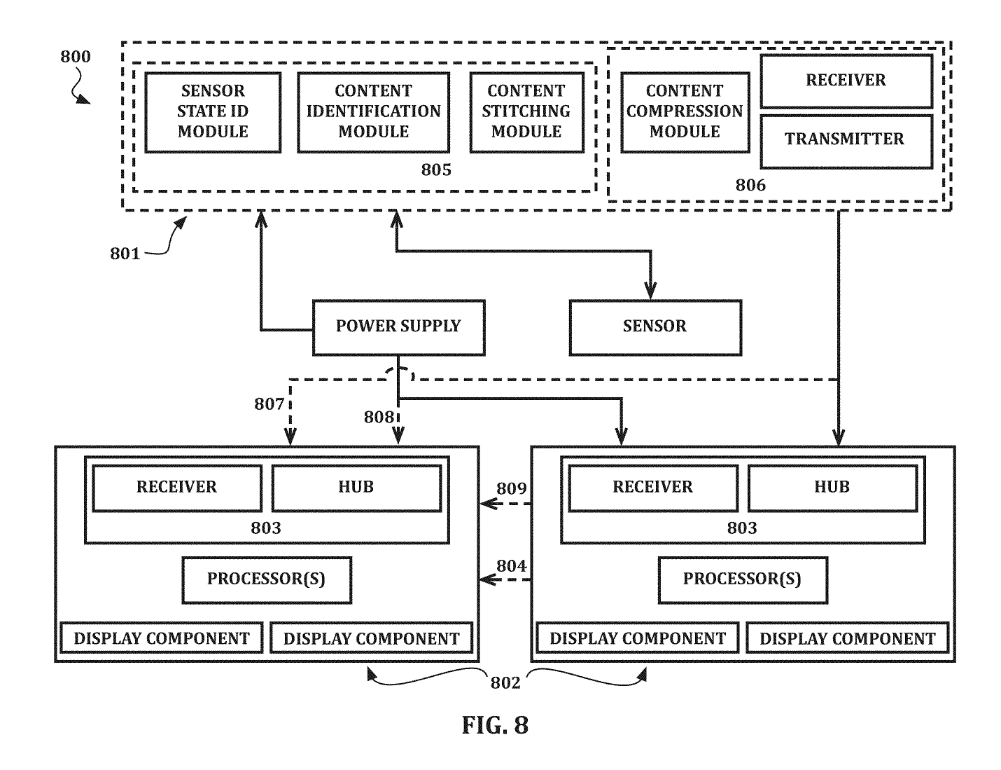

FIG. 5 illustrates an exemplary segmentation schematic of graphic or sending card display configurations into smaller height segments used in the display units and systems provided herein. As illustrated, an exemplary graphics (or sending) card 501 (e.g., QWXGA graphics card) provides image content to a pixel array 502 (e.g., 2048×1152). In specific instances, a single QWXGA graphics card of 2048×1152 supports 2,359,296 pixels in a system provided herein. Optionally, other graphics (or sending) cards are alternatively utilized to prepare other segmentation schemes. Other graphics cards or sending cards supporting various graphics arrays, such as XGA (1024×768), WXGA (1366×768), XGA+ (1152×864), WXGA+ (1440×900), SXGA (1280×1024), SXGA+(1400×1050), WSXGA+ (1680×1050), UXGA (1600×1200), WUXGA (1920×1200), and many other types are optionally utilized. In specific embodiments, particularly those involving LED displays, graphics or sending cards provided herein support a system comprising more pixels. For example, in some embodiments, dual sending cards provided herein support twice as many pixels. Further, in some embodiments, the system is configured to provide failover (e.g., by being configured to provide display information to a first and a last display unit of the system), thereby support half as many pixels. Segmentation of such a 2048×1152 array provides, for example, forty-eight (48) segments 503 for display units having a height of 24 pixels. In other examples, using such a segmentation scheme is used to provide content to 36 segments for display units having a height of 32 pixels. In some embodiments, systems provided herein are configured as continuous displays (e.g., limited only by the display size desired), e.g., utilizing such techniques. FIG. 6 illustrates the logical layout on a shelf face of such a segmentation configuration (e.g., to create a width of greater than the pixel array width generally supported by a specific graphics card, such as a width greater than 2048 for QWXGA graphics cards). In some embodiments, provided in a system, e.g., a controller thereof, is a segmentation module configured to segment a graphics array to provide display content for a high aspect ratio system display array (e.g., a system display array of greater than that typically supported by the graphics card). In such embodiments, segmentation allows for a single graphics card to provide display content to a very high aspect ratio system display array of 98,304×24 for displays having a height of 24 pixels (e.g., up to over 900 display units having an LED or LCD array of 160×24) or 73,728×32 for displays having a height of 32 pixels (e.g., up to over 450 display units having an LED or LCD array of 160×32). Further, as illustrated in FIG. 5, with additional (n) graphics cards 504, additional display content is optionally provided to additional (n) arrays 505 that are similarly segmented. As is illustrated in FIG. 7, however, global and local display content is not limited by the segment or display sizes. In some instances, content segments optionally span two or more adjacently configured display units. Depending on how the products are arranged, for example, segmented content (701-708) is optionally stitched together (e.g., by a stitching module discussed herein) in any suitable manner. In some embodiments, such as in embodiments utilizing LCD displays, sending or receiving cards configured to convert conventional video output formats into those recognizable by the display are unnecessary and standard digital video interfaces or the like may be employed.

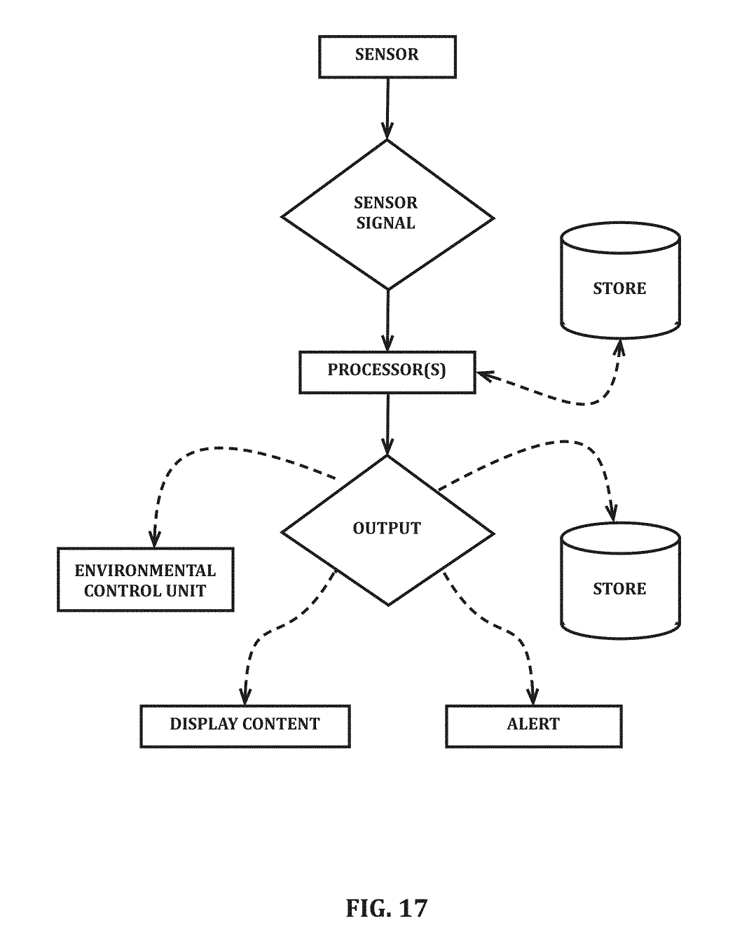

In some embodiments, provided herein is a display system comprising one or more display unit and a controller. FIG. 16 illustrates an exemplary system 1600 comprising a controller 1601 and one or more display unit 1602. A single controller is illustrated comprising a plurality of controller subunits combined to serve the function of the system controller. In some instances, a controller comprises one or more processors configured to execute one or more controller program module. Exemplary program modules comprise, by way of non-limiting example, a sensor state identification modules (e.g., configured to monitor or detect sensor states, including operating parameters thereof), content identification module (e.g., configured to identify predetermined information to be provided to the one or more system display units based on the status of a sensor state), a content stitching module (e.g., configured to stitch the predetermined information (e.g., corresponding to local display information to ultimately be displayed at the display unit(s)) together, such as to form a global system display information, a content compression module (e.g., configured to compress display information), or combinations thereof. In some instances, a controller provided herein further comprises a transmitter configured to provide global system display information (e.g., compressed or not), to one or more system display unit 1602. As illustrated, in some embodiments, a display unit (e.g., display strip) comprises a receiver configured to receive display information (e.g., global system display information or local display information). As further illustrated, in certain embodiments, a display unit (e.g., display strip) comprises one or more output (e.g., an output hub as illustrated) configured to provide display information (e.g., local display information) to one or more display component (two display components are illustrated, but units comprising a single or more than two display components are contemplated). In certain embodiments, a display unit provided herein comprises a receiver and an output (e.g., configured to provide display information to the display components). In some instances, the output is an output hub, as illustrated in FIG. 16, configured to provide display information to more than one display component of the display unit. In certain embodiments, a display unit provided herein further comprises one or more processor (e.g., FPGA) configured to execute program modules, such as any one or more of the various display unit program modules discussed herein. In certain embodiments, a display unit provided herein comprises an output configured to convey or transmit display information 1604 (e.g., global system display information) to another system display unit (e.g., by daisy-chaining). In other embodiments, a controller 1601 provided herein optionally provides display information (e.g., global system or local display information) directly 1607 to individual display units. In some embodiments, a system provided herein comprises one or more power supply. In certain embodiments, the system comprises at least one power supply (e.g., a switching power supply configured to convert AC to DC, such as about 5 Vdc) configured to provide power to one or more display unit and at least one power supply configured to provide power to the controller. In some instances, the system comprises one or more power supply that is configured to provide power directly 1608 to one or more display units, configured to provide power directly to a first display unit and chained 1609 to a second display unit, or a combination thereof. In certain embodiments, the system 1600 further comprises one or more sensor, e.g., configured to provide sensor output signals (e.g., the sensor output signals conveying information regarding a sensor state—e.g., a state of an operating parameter) to a controller 1601. In specific instances, the controller 1601 comprises a display controller subunit configured to provide predetermined display information to one or more display unit of the system. In some instances, the display controller provides display information to the one or more display units based on the sensor state of the system. In certain embodiments, the system comprises a forward and/or rear sensor configured to convey information to one or more sensor controller, such as a rear sensor controller and/or forward sensor controller as illustrated in FIG. 16. In some instances, the sensor controller(s) comprise a module configured to determine the sensor state(s) (which is then optionally used by the display controller to determine the display information to convey to the one or more display units). In specific embodiments, the display controller is configured to retrieve display information from a data store based on the sensor state(s) identified by the sensor controller(s). In some embodiments, the display controller is configured to retrieve display information from a data store based on the sensor state(s) identified by a forward sensor controller (e.g., based on sensor information conveyed from one or more forward facing sensor). In certain embodiments, the rear sensor controller is configured to receive rear sensor signals from one or more rear facing sensor (e.g., a sensor facing in a direction about 90 degrees to 180 degrees opposed to the viewable surface of the display unit/component), and comprises a module configured to identify the number of product or merchandise in proximity to the sensor and/or identify any misplaced products or merchandise. In some embodiments, identification of such information (e.g., sensor states) is utilized by system modules configured to determine display information provided to the displays, and/or to write a record of such information to a data store, which information is accessible by a personal computer, a tablet, or the like (e.g., used to keep inventory records). Similar systems and methods are optionally utilized for if environmental sensors are used in addition to or instead of a rear-facing sensor (e.g., camera). In some instances, power is provided to the sensor via a controller power supply (as illustrated—such as through a USB connection) or a display unit power supply. In other instances, a sensor comprises its own power supply. In certain embodiments, one or more display unit of the system comprises the sensor mounted therein or thereon.

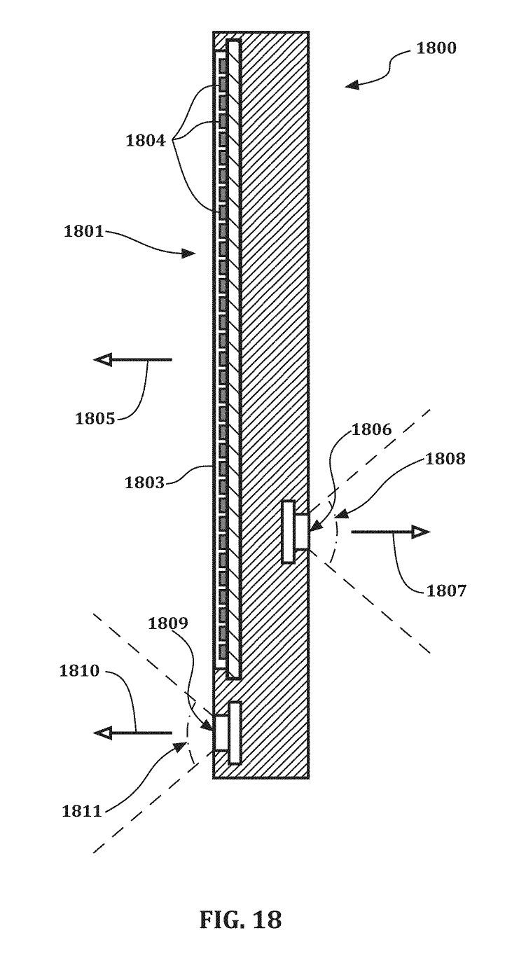

As more generally illustrated in FIG. 17, in some embodiments, provided herein is a system comprising a sensor configured to provide an output signal to a sensor controller, the output signal conveying information regarding a state in proximity to sensor (or a display unit comprising the sensor). In specific embodiments, the sensor is a camera (e.g., a rear facing camera), or an environmental sensor (e.g., a humidity or temperature sensor). In certain embodiments, the sensor controller comprises one or more processor configured to execute one or more sensor controller program module. In specific embodiments, the sensor is a rear facing camera (e.g., the camera is configured to face in a direction about 90 degrees to 180 degrees opposed to the viewable display surface of one or more display unit of the system, such as the viewable display surface of a display unit in which the sensor is housed) and the one or more sensor controller program module comprises a module configured to determine whether any objects (e.g., products or merchandise) in proximity (e.g., within about 10 feet, about 5 feet, or about 3 feet) of the sensor are out of place (e.g., a first module configured to access a data store comprising information about what objects are assigned to be in proximity to the sensor and a second module configured to compare the objects in proximity to the sensor to the objects assigned to be in proximity to the sensor); a module configured to determine the amount of objects there are in proximity to the sensor (e.g., a first module configured to access a data store comprising information about what objects are assigned to be in proximity to the sensor and a second module configured to count or approximate the number of object assigned to be in proximity to the sensor are actually in proximity to the sensor); or a combination thereof. In other specific embodiments, the sensor is an environmental sensor (e.g., a temperature and/or humidity sensor) and the one or more sensor controller program module comprises a module configured to determine the status of an environmental state (e.g., temperature and/or humidity) in proximity to the sensor; a module configured to determine whether the environmental state is outside an acceptable level (e.g., temperature above a predetermined value, temperature below a predetermined value, humidity above a predetermined value, humidity below a predetermined value, or any combination thereof) in proximity (e.g., within about 10 feet, about 5 feet, or about 3 feet) of the sensor (e.g., a first module configured to access a data store comprising information about predetermined acceptable environmental conditions (e.g., temperature and/or humidity) in proximity to the sensor and a second module configured to compare the environmental conditions in proximity to the sensor to the acceptable environmental conditions assigned to be in proximity to the sensor); or a combination thereof. In some embodiments, the sensors comprise both a rear facing camera and an environmental sensor. In some embodiments, the sensor controller further comprises one or more module configured to record or write the determined condition (e.g., amount of an object, and/or temperature and/or humidity) to a data store (e.g., a hard drive, cloud storage, or the like); to send an alert output signal (e.g., to a display, a light, an audio receiver, a personal computer, a database, or the like), e.g., if a determined condition (e.g., amount of an object, temperature, and/or humidity) fails to satisfy a predetermined (acceptable) condition; or a combination thereof. In some specific embodiments, the sensor controller further comprises a module configured to send an output signal to an environmental control unit (e.g., temperature control unit (e.g., refrigeration unit) or humidity control unit) in proximity to the sensor. In further specific embodiments, the system further comprises an environmental control unit (e.g., temperature control unit or humidity control unit) configured to receive the output signal and adjust the environmental conditions (e.g., temperature and/or humidity) in proximity to the sensor.

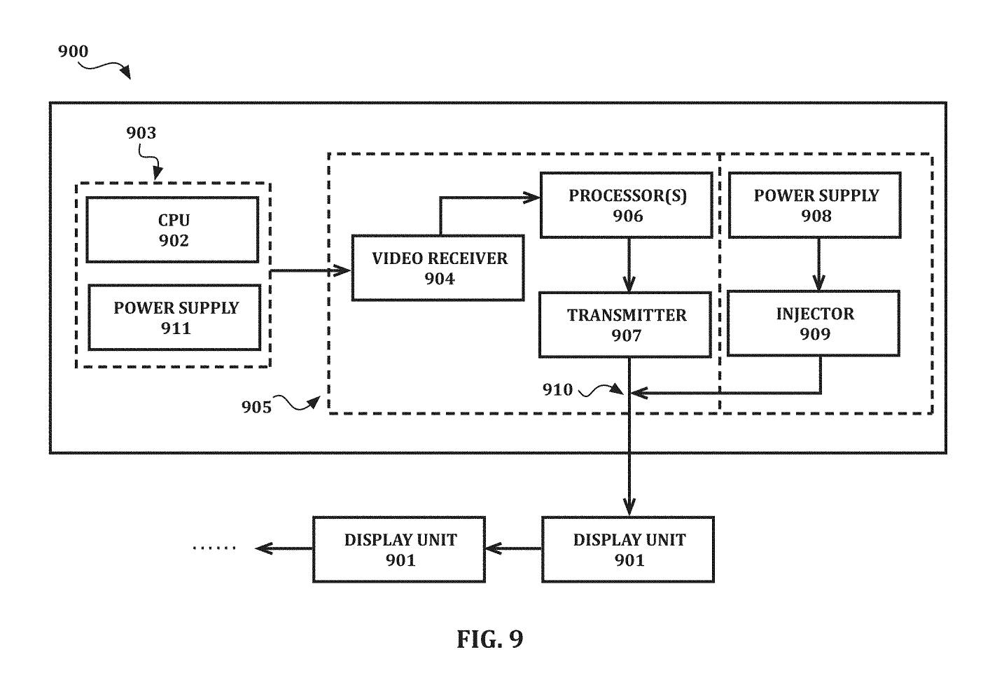

FIG. 8 illustrates an exemplary system 800 comprising a controller 801 and one or more display unit 802. A single controller is illustrated comprising a plurality of components, however, several controller subunits are optionally combined to serve the function of the controller. In some instances, a controller comprises one or more processor 805 configured to execute one or more controller program module. Exemplary program modules comprise, by way of non-limiting example, a sensor state identification modules (e.g., configured to monitor or detect sensor states, particularly operating parameters thereof), content identification module (e.g., configured to identify predetermined information to be provided to the one or more system display units based on the status of the sensor state(s)), a content stitching module (e.g., configured to stitch the predetermined information (e.g., corresponding to local display information to ultimately be displayed at the display unit(s)) together, such as to form a global system display information, a content compression module (e.g., configured to compress display information), and combinations thereof. In some instances, a controller provided herein further comprises a transmitter configured to provide global system display information (e.g., compressed or not), to one or more system display unit 802. In certain embodiments, a system (e.g., controller thereof) provided herein comprises a sending card 806 configured to receive global system display information (e.g., in video format via AVI), a content compression module configured to compress the global system display information, and a transmitter configured to provide the global system display information to a system display unit 802. As illustrated, in some embodiments, a display unit (e.g., display strip) comprises a receiver configured to receive display information (e.g., global system display information or local display information). As further illustrated, in certain embodiments, a display unit (e.g., display strip) comprises one or more output (e.g., an output hub as illustrated) configured to provide display information (e.g., local display information) to one or more display component. In certain embodiments, a display unit provided herein comprises an integrated receiver/hub card, wherein the receiver input and the hub outputs are configured into a single card 803. In some embodiments, integrating the receiver and display output hub allows further compacting of the display unit, which, in some instances, reduces the chances of the display unit being impacted and/or damaged, requiring replacement. In certain embodiments, a display unit provided herein further comprises one or more processor (e.g., FPGA) configured to execute program modules, such as any one or more of the various display unit program modules discussed herein. In certain embodiments, a display unit provided herein comprises an output configured to convey or transmit display information 804 (e.g., global system display information) to another system display unit (e.g., by daisy-chaining). In other embodiments, a controller 801 provided herein optionally provides display information (e.g., global system or local display information) directly 807 to individual display units. In some embodiments, a system provided herein comprises one or more power supply. In certain embodiments, the system comprises at least one power supply (e.g., a switching power supply configured to convert AC to DC, such as about 5 Vdc) configured to provide power to one or more display unit and at least one power supply configured to provide power to the controller. In some instances, the system comprises one or more power supply that is configured to provide power directly 808 to one or more display units, configured to provide power directly to a first display unit and chained 809 to a second display unit, or a combination thereof. In certain embodiments, the system 800 further comprises one or more sensor, e.g., configured to provide sensor output signals (e.g., the sensor output signals conveying information regarding a sensor state—i.e., a state of an operating parameter) to a controller 801. In some instances, power is provided to the sensor via a controller power supply (as illustrated) or a display unit power supply. In other instances, a sensor comprises its own power supply. In certain embodiments, one or more display unit of the system comprises the sensor mounted therein or thereon.

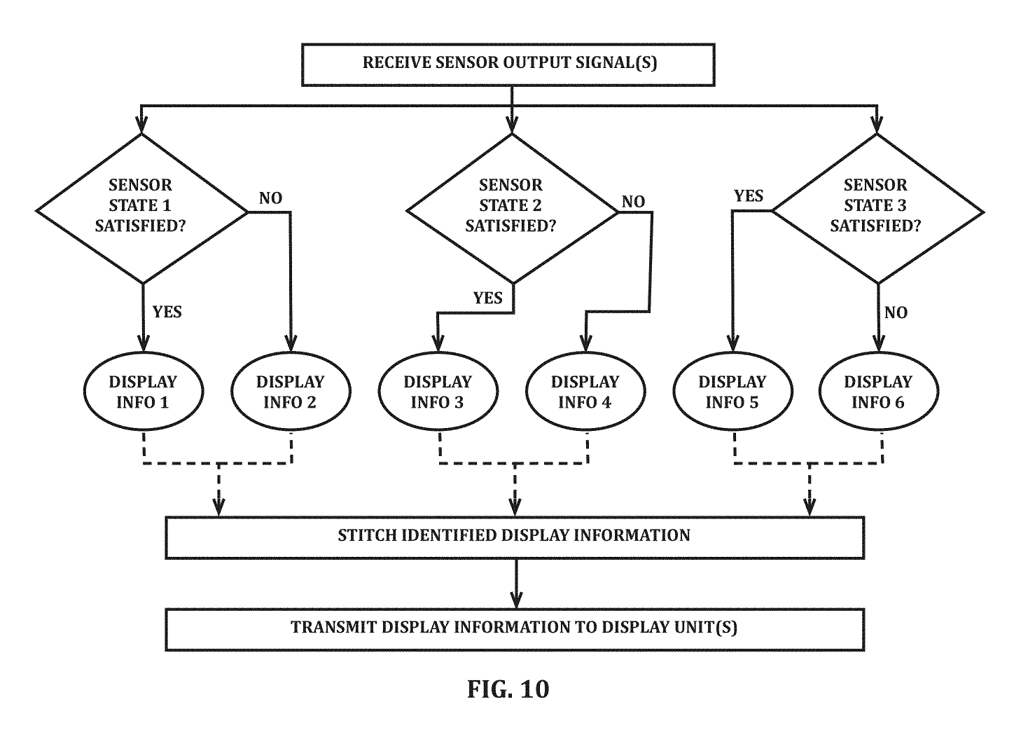

FIG. 9 illustrates an exemplary controller 900 configured to provide power and display information to one or more display unit 901 provided herein. In some instances, a controller provided herein comprises one or more processor (e.g., a CPU) 902 and one or more power supply 911 therefor. In some embodiments, a computer 903, such as a personal computer (PC), comprises the one or more processors and power supply therefor. In certain instances, program modules, such as modules configured to detect or monitor operating parameters (such as sensor states) of the system or display units thereof, identify predetermined information to be displayed on the various display units of the system based on the status of the operating parameters, stitch the predetermined information together to generate global system display information, and/or the like, are executed by the one or more processors 902 of the computer 903. In some instances, the computer 903 is configured to transmit or convey a video signal conveying global system display information to a video receiver 904 (e.g., of a sending card 905). In some embodiments, the system (e.g., sending card thereof 905) comprises one or more processor 906 (e.g., FPGA) configured to compress the global system display information (e.g., to allow for transmission of large quantities of content over various cable types, such as Ethernet cables, which also allows integrated transmission of display information and power to the display units). In some instances, the system (e.g., sending card thereof) further comprises a transmitter 907 (e.g., Ethernet transmitter) configured to provide global system display information to one or more system display unit. Further, in some embodiments, such as wherein Ethernet cables (or other cables capable of transmitting information and power, such as USB) are utilized, a power supply 908 and injector 909 are configured to inject power into a cable 910 (e.g., a T568B Ethernet cable, or any other cable suitable for transmitting display information and power) configured to transmit display information to a display unit. In various embodiments, the power supply and injector are optionally included together with, or separate from, a sending card comprising the video receiver, processor(s), and transmitter.

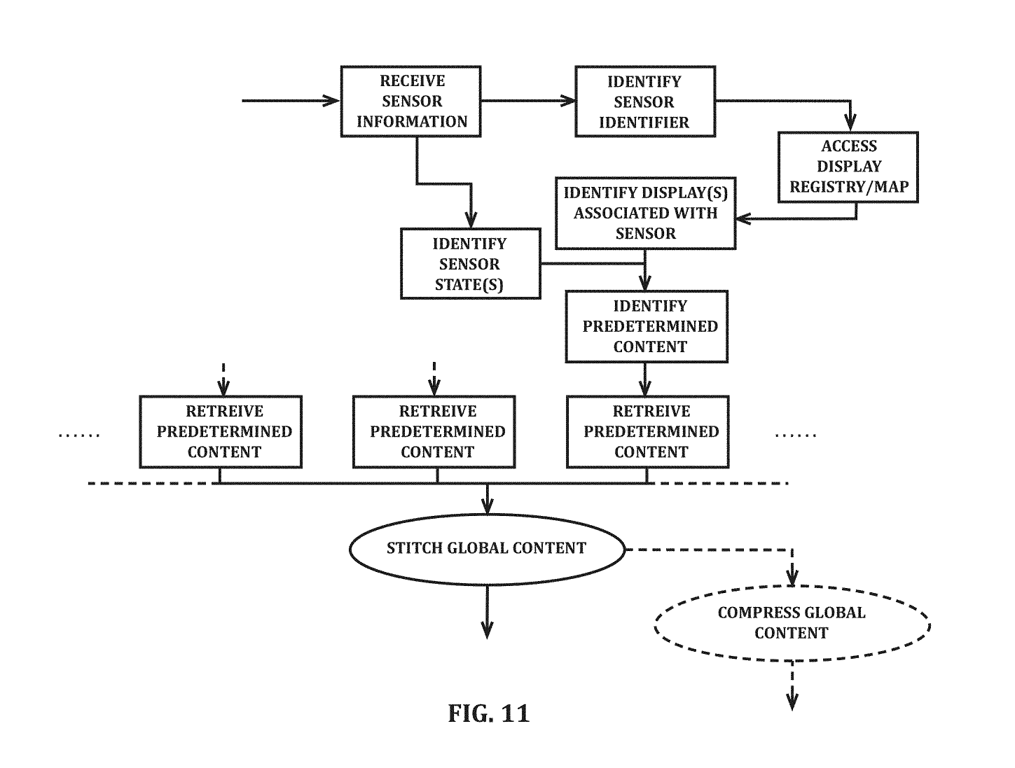

FIG. 10 illustrates a schematic of modules described herein configured to receive sensor output signal (e.g., from one or more sensor), identify the status of one or more sensor state (e.g., proximity) associated with one or more display units (e.g., proximity to one or more display units), identify display information corresponding to the identified sensor state(s), and stitch together display information corresponding with the sensor states (e.g., wherein more than one predetermined display information is identified as corresponding to one or more sensor state). In some instances, a single sensor provides output signal that conveys information regarding the sensor state of one or more display unit. For example, in some embodiments, Sensor State 1 corresponds to proximity to a first display unit, Sensor State 2 corresponds to proximity to a second display unit, and Sensor State 3 corresponds to proximity to a third display unit. In certain embodiments, once global system display information has been stitched together, it is transmitted to the one or more display units.

In some embodiments, provided herein is a method for displaying (e.g., interactively displaying) product information in a physical location, such as a retail store (i.e., at a brick-and-mortar merchant). In specific embodiments, the product information is displayed at the front edge of one or more shelf of the location. For example, in some embodiments, it is possible to display such product information in such a manner by affixing or integrating one or more display unit provided herein with one or more shelf at the location. Display units and systems provided herein make it possible to display such information in a cost effective manner. In some embodiments, once one or more display units, such as a shelf display unit provided herein, is mounted at the location (e.g., affixed to or integrated with a shelf of the location), it is possible to display (e.g., interactively display) product information at the location.

In some embodiments, provided herein is a method for dynamically displaying product information in a physical location to a person or customer physically located at the location. In some embodiments, the method comprises providing one or more display unit and one or more sensor at the location (e.g., affixed to and/or integrated with shelving units thereof). In certain embodiments, the method comprises:
i. receiving a sensor output signal from a sensor, the sensor output signal conveying information regarding a sensor state (e.g., location of and/or proximity of a person or customer, such as in relation to the sensor) of the sensor;
ii. determining a sensor state based on the received output signals from the sensor;
iii. identifying predetermined display information associated with the identified sensor state from a display information store (e.g., database); and
iv. providing the predetermined display information to the one or more display units.

In certain embodiments, a controller (e.g., comprising one or more controller units), such as described herein, receives the sensor output signal, determines the sensor state, and identifies the display information. In some embodiments, the process further comprises displaying video, images, and/or text associated with the display information on the one or more display units.

In specific embodiments, the sensor output signal further comprises information that identifies the sensor from which the output signal originated. In some instances, this is useful in system comprising multiple display units and multiple sensors. In certain embodiments, the method further comprises determining the identity of the sensor based on the information that identifies the sensor (a sensor identifier) from which the output signal originated. In some embodiments, the process further comprises determining the display unit(s) associated with the sensor (e.g., a display unit or display units in which the sensor is located and/or nearby the sensor or display unit in which the sensor is located). In certain embodiments, the display unit(s) associated with the sensor are determined by accessing a display registry or map, and correlating the sensor identified or sensor identifier with display unit(s) associated with the sensor identified or sensor identifier.

In certain embodiments, a method provided herein comprises identifying predetermined display information associated not only with the identified sensor state, but also with the identified display unit(s), from a display information store (e.g., database). In some embodiments, multiple display units and multiple sensors are present in the system, e.g., being operated by a controller. In certain embodiments, a process or system provided herein comprises receiving or one or more module configured to receive multiple sensor output signals, each sensor output signal convening information regarding one or more sensor state. In some embodiments, a process or system provided herein comprises determining or a module configured to determine multiple sensor states based on the received output signals from the sensors. In some embodiments, a process or system provided herein comprises identifying or a module configured to identify predetermined display information associated with the identified sensor states from a display information store (database). In certain embodiments, a process or system provided herein comprises providing or one or more transmitter or output configured to provide the predetermined display information to the one or more display units.

In specific embodiments, the sensor output signals further comprise information that uniquely identifies the sensors from which the unique output signals originated. In certain embodiments, the method or a system provided herein further comprises determining or a module configured to determine the identity of the sensors based on the information that identifies the sensors (or a sensor identifier) from which the output signal originated. In some embodiments, the method or a system further comprises determining or a module configured to determine the display unit(s) associated with each sensor (e.g., a display unit or display units in which each sensor is located and/or nearby the sensors or display unit in which the sensors are located). In certain embodiments, the display unit(s) associated with the sensors are determined by accessing a display registry or map, and correlating the sensors identified or sensor identifiers with display unit(s) associated with the sensors identified or sensor identifiers.

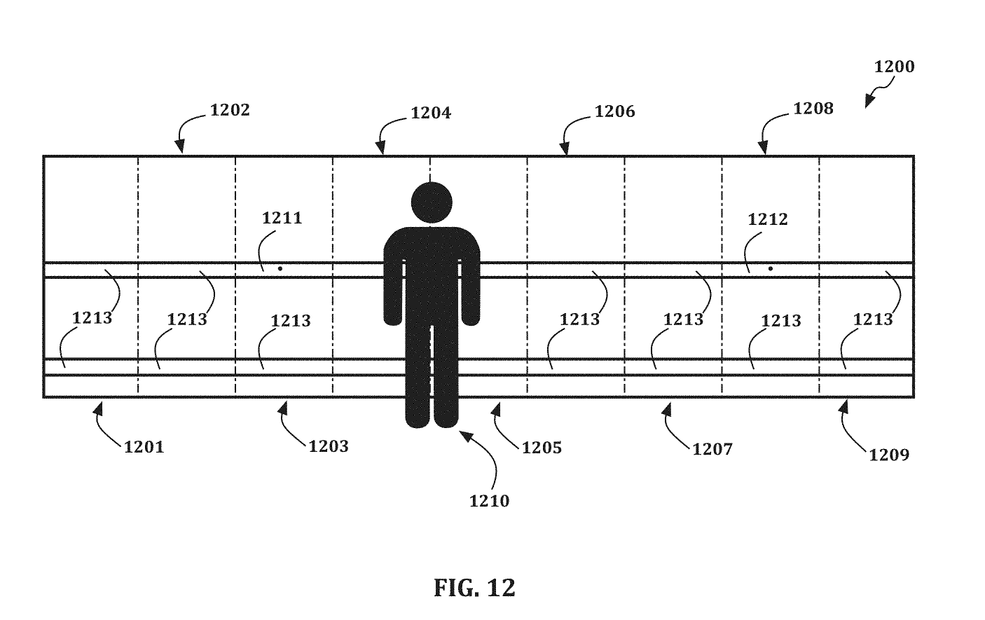

As illustrated in FIG. 11, in certain embodiments, predetermined display information is identified and retrieved based on the sensor states identified from multiple sensors. In some instances, once the multiple iterations of predetermined multiple display information is retrieved it is stitched in global system display information and optionally compressed for dissemination to the display units. In certain embodiments, the global system display unit is stitched in a logical order (e.g., as illustrated in FIG. 5 and FIG. 6) to allow for correlation with the correct display information with the correct display units, e.g., based on which display unit(s) are associated with which sensors, as well as how (e.g., order, location, etc.) the display units are associated with the sensors (which can be determined, e.g., by accessing a display unit registry and/or map).

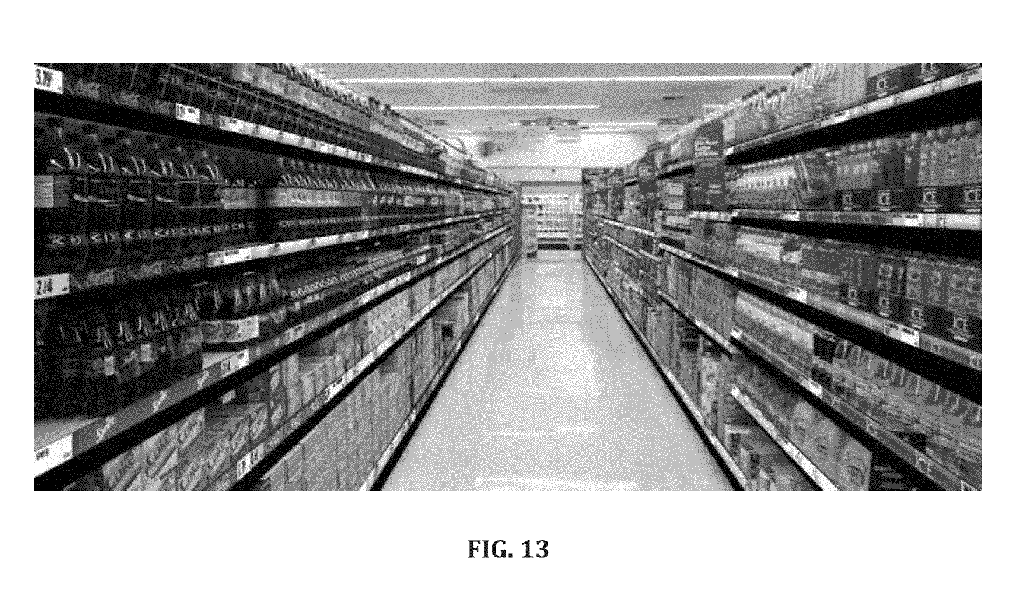

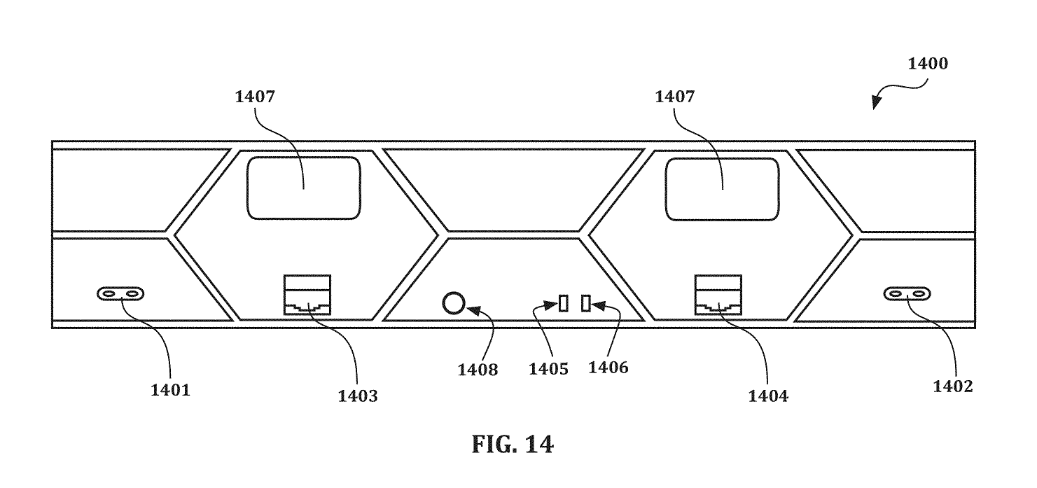

FIG. 12 illustrates an exemplary retail system 1200 provided herein comprising a first display unit 1211 comprising a first sensor (e.g., camera), a second display unit 1212 comprising a second sensor (e.g., camera), and multiple additional display units 1213. In some instances, the first sensor 1211 is configured to detect multiple sensor states, such as in sensor zones 1201-1205. In some instances, sensor output signals from the sensor in display unit 1211 comprise information regarding sensor states in sensor zones 1201-1205. For example, in the illustration, a person is located in front of the shelving system in sensor zones 1204 and 1205. For example, therefore, the sensor in display unit 1211 is configured to send output signals comprising information about sensor states 1201-1205, and, receiving that information, the controller comprises a module configured (e.g., based on the sensor identity or identifier and the sensor state information) to identify the sensor state of sensor zone 1201 as having no person in sensor zone 1201, identify the sensor state of sensor zone 1202 as having no person in sensor zone 1202, identify the sensor state of sensor zone 1203 as having no person in sensor zone 1203, identify the sensor state of sensor zone 1204 as having a person 1210 in sensor zone 1204, and identify the sensor state of sensor zone 1205 as having a person 1210 in sensor zone 1205. In such examples, the controller is also configured to receive information from a second sensor (in display unit 1212), and one or more module configured to identify the sensor state of sensor zones 1206-1209 as having no person located therein. In some instances, based on such sensor state identification, e.g., using system components and/or modules or processes described herein, specific display information for the various display units in the various sensor zones of the system is identified, retrieved, and stitched into global system display information that is provided to the system display units (e.g., wherein the display units are configured to identify the subset of global display information that is local thereto, and display such local display information). FIG. 13 illustrates an exemplary depiction of a retail store aisle comprising one or more retail display system provided herein.

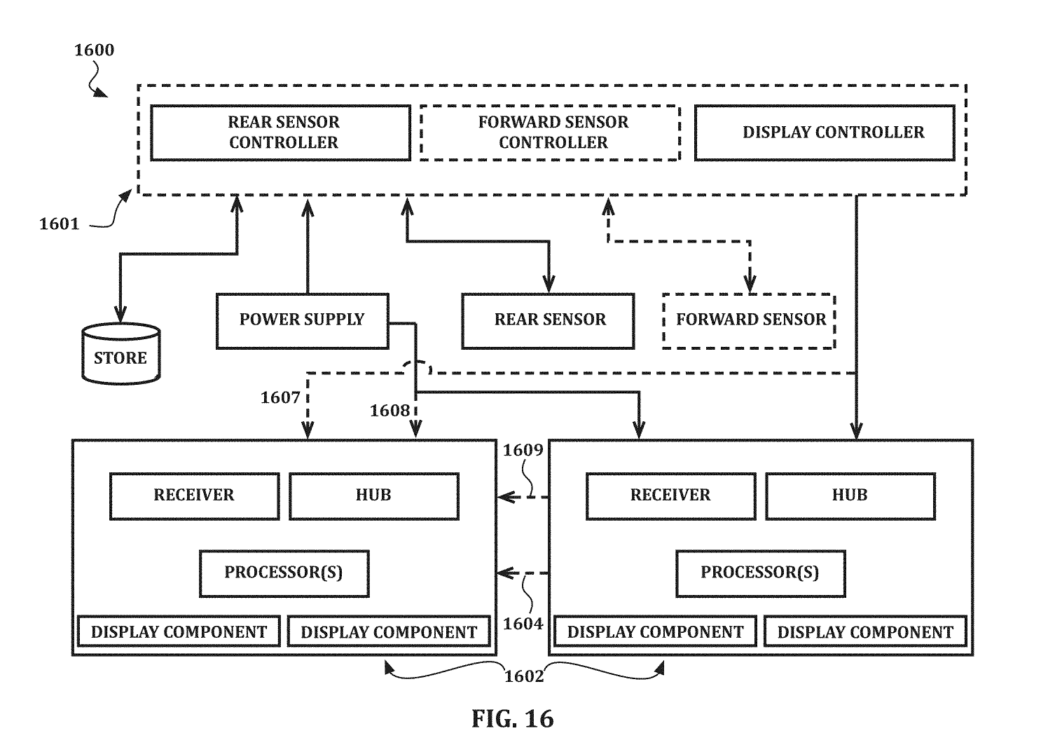

In certain embodiments, display information provided to the display units and systems described herein is any suitable display information, including, by way of non-limiting example, video, images, text, and combinations thereof. As discussed herein, in preferred embodiments, display units provided herein comprise an array of LED pixels, the array having a height of 30 pixels or more. As illustrated in FIG. 15, such array sizing allows for up to at least 4 lines of aesthetically pleasing text, with spacing between the text. In addition, good quality resolution images (such as product logos, QR codes, and the like) and video can also be displayed. In certain embodiments, display units and systems thereof (or processors thereof) are configured to display text fonts having a height of (at least) 7 pixels and a width of up to (at least) 5 pixels 1501. In some embodiments, larger fonts are optionally utilized, such as those having a height of 14 pixels and a width of up to 10 pixels 1503. In some embodiments, QR Codes have a height and width of up to 29 pixels 1502. In certain embodiments, a display unit provided herein provides a single content segment (or tag) that extends along the entire width of the unit (e.g., 160 pixel wide segment 1500 of the unit illustrated in FIG. 15). In other embodiments, a display unit herein is optionally divided into multiple content segments, such as half the display unit (e.g., an 80 pixel wide segment), a quarter (e.g., a 40 pixel wide segment), or any suitable fraction of the display unit.

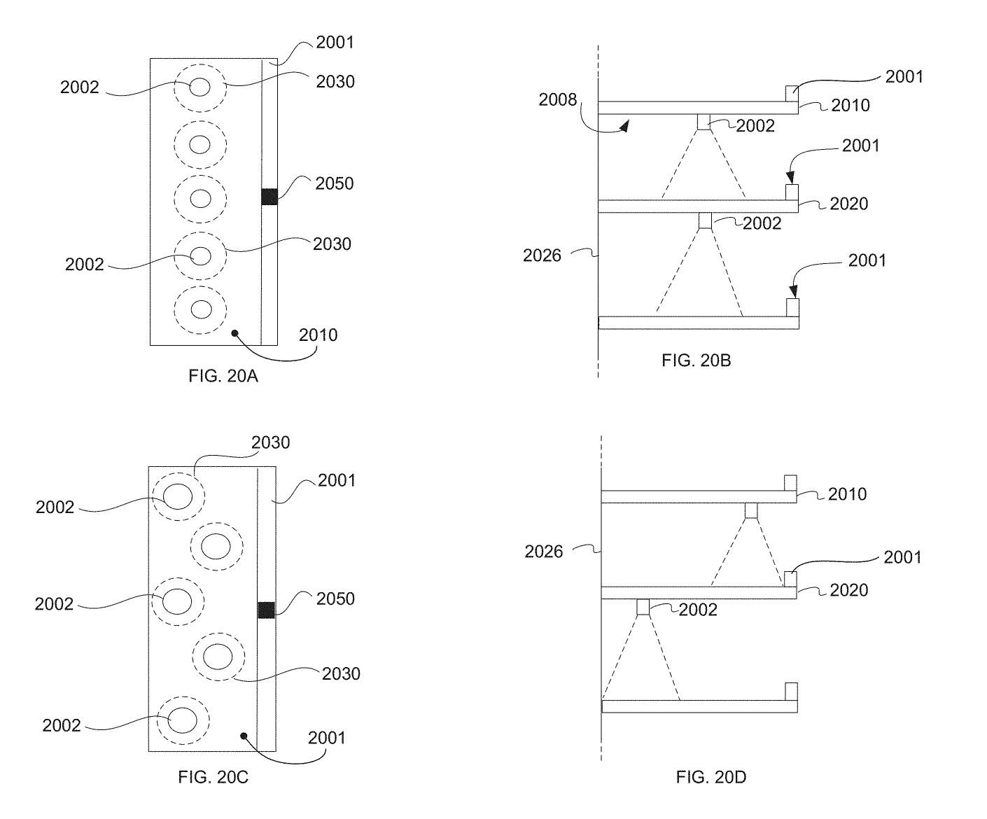

In certain embodiments, such as illustratively displayed by way of non-limiting example in FIG. 19, the display unit 1901 comprising a viewable display 1902 (e.g., comprising an array of coated 1903 and viewable LED pixels 1904) is attached to or integrated with a shelf 1911 and is configured to face in a first direction 1905. In some embodiments, provided herein is a shelving system (e.g., retail shelving system) comprising a plurality of shelves comprising one or more display unit attached to or integrated therewith. In some embodiments, the display unit comprises a first sensor configured to detect product in proximity to the display unit. In specific embodiments, the first sensor is a camera 1906 configured to face a second direction 1907, e.g., in a rear facing direction, as discussed herein. In some embodiments, provided herein is a system (e.g., inventorying system) wherein a camera is affixed to or integrated with a shelving unit and is configured to capture and/or convey information about objects (e.g., product or merchandise) situated in proximity to (e.g., on a shelf below) the camera. In specific embodiments, the camera is integrated with a display unit provided herein, the camera being configured to be accepted into the display unit housing on the lower half, e.g., lower third or lower quarter, of the housing. In some embodiments, this configuration allows the camera to hang below the bottom face of a shelf and/or be in a better position to view objects in proximity to the camera. In certain embodiments, the first sensor is configured to detect objects 1912 (e.g., product or merchandise) in proximity to the display unit or first sensor and to send output signals (e.g., to a system controller) conveying information about the objects in proximity to the first sensor. In some embodiments, a system controller (not illustrated in FIG. 19) comprises a module configure to compare sensor information received from the first sensor (e.g., an image of an object captured by a camera) to information (e.g., retrieved from a data store) about an object assigned to be in proximity to the first sensor (e.g., and a module configured to access a data store configured to store accessible information regarding objects assigned to be in proximity to the sensor). In some embodiments, the module is configured to compare images of the objects in proximity to the sensor to images of objects assigned to be in proximity to the sensor. In other specific embodiments, (e.g., wherein the sensor is an RFID sensor) the module is configured to compare RFIDs of objects in proximity to the sensor or display unit to RFIDs of objects assigned to be in proximity to the sensor or display unit. In yet other specific embodiments, (e.g., wherein a sensor film is placed on the shelf to which the display unit is attached or integrated) the module is configured to compare a sensor state (e.g., weight) of the objects present on the shelf to information about the state (e.g., weight of) an object assigned to be on the shelf (and, e.g., a module configured to divide the total weight on the shelf by the weight of an object assigned to be on the shelf to arrive at the number of objects assigned to be on the shelf that are on the shelf). In still other specific embodiments, the module is configured compare the amount of space taken up proximity to the sensor (e.g., on a shelf) compared to the amount of space taken up by each object assigned to be in proximity to the sensor. For example, a module is configured to look for a pattern on the shelf (e.g., markers on a shelf). As an example, when the shelf is empty, each foot of shelving has x (10-1000, such as 216—one by one inch for an 18″ deep shelf per 1′ of shelf) number of markers (e.g., actual markers—such as dots, or a program construct thereof), and none of the markers are obstructed by product. In some instances, the module is configured to compare the number of markers obstructed to the number of markers each object assigned to be at the location would obstruct if located on the shelving. As such, in some embodiments, a controller module herein is configured to count visible markers on a shelf, compare the number of markers assigned to be in proximity to the sensor to the number of markers visible, and further compare the number of non-visible markers to the number of markers obstructed by an object in proximity to the sensor (e.g., in order to make a determination of the number of assigned objects—product or merchandise—in proximity to the sensor). In addition, in some embodiments, the display unit comprises a sensor configured to detect the sensor state of an operable parameter of the content displayed on the display unit, such as, e.g., a motion detector, forward facing camera (e.g., the configuration of which is described herein, particularly facing in a third direction 1910, such as that is within 90 degrees of the first direction), or other sensor suitable for detecting the presence of a person (e.g., customer in a retail environment) in proximity to the display unit.

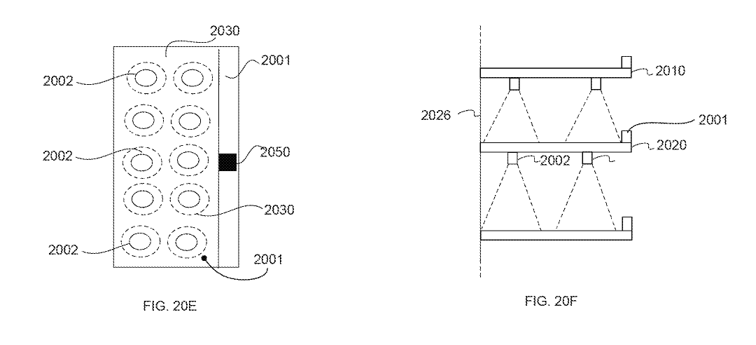

Turning now to FIGS. 20A-20F, in other embodiments a plurality of ultrasound sensors 2002 may be utilized to detect a “stock-out” condition, i.e., the absence or near-absence of a given product on a retail shelf. In the exemplary stock-out alert reporting (“SOAR”) system of FIGS. 20A-20F, the plurality of ultrasound sensors 2002 (e.g., each typically comprised of an ultrasound emitter/receiver pair) may, for example, be arranged on the underside 2008 of an upper shelf 2010 overhanging a lower shelf 2020 upon which products (not shown) are arranged. The lower shelf 2020 may include a display unit 2001 in communication through wiring (not shown) with the ultrasound sensors 2002 on the underside 2008 of the overhanging upper shelf 2010. FIGS. 20A and 20C depict two different exemplary patterns in which a set of five ultrasound sensors may be arranged. FIG. 20E depicts an exemplary pattern using a set of ten ultrasound sensors. The upper shelf 2010 and lower shelf 2020 may be anchored to a vertical support structure 2026 or wall. In one embodiment operation of the SOAR system involves sending, from an ultrasound emitter of one of the ultrasound sensors 2002, a pulse that bounces off of a portion of the lower shelf 2020 not occupied by products or merchandise. The returning pulse is received by the ultrasound receiver of the ultrasound sensor 2002. The delay between send and receive is measured and this “round-trip-delay’ (RTD) and is recorded as the reference RTD for the shelf 2020. The shelf 2020 is then stocked with merchandise and the ultrasound emitter/receiver of each ultrasound sensor 2002 periodically sends/receives monitoring pulses. As long as the measured RTD recorded by the ultrasound sensor 2002 for each of these periodic ultrasound monitoring emissions is less than the reference RTD, then a “stock on shelf” condition exists with respect to the lower shelf 2020. As stock on the lower shelf 2020 is depleted, the ultrasound sensor 2002 will start recording monitoring RTDs that are equal to the reference RTD, indicating out of stock conditions.

One advantage of utilizing a reference RTD is that doing so obviates the need for re-calibration when the type or size of the product items stocked on the shelf are changed. This is because the reference distance and RTD is independent of the quantity or character of the products that may be stocked on the applicable shelf. When the products stocked on the shelf are changed, a stock-out condition still occurs when the measured RTD become approximately the same as the reference RTD. This differs from methods to, for example, determine levels of inventory using cameras or the like, which require re-calibration when product items having a different size or shape are substituted for existing product items on retail shelving. The present approach also enables retail shelving to be reconfigured with alternative separations between shelves without the need for performing a separate re-calibration procedure. Again, the use of a reference RTD results in the configuration in which the retail shelves are placed being inherently taken into account when determining stock-out conditions.

As shown in FIGS. 20A, 20C and 20E, the upper shelf 2010 may include multiple ultrasound sensors 2002 capable of determining the presence or absence of products within a coverage area 2030. This enables embodiments of the SOAR system to provide multiple reporting thresholds. For example, in the embodiments of FIGS. 20A-20D the underside 2008 of the upper shelf 2010 may be configured with a set of 5 ultrasound sensors 2002, each designed to cover approximately 20% of the surface are of the lower shelf 2020. As a consequence, alerts can be generated for out of stock conditions corresponding to 20%, 40%, 60%, 80%, and 100% stock depletion levels. The intervals at which the ultrasound sensors 2002 emit pulses are configurable, as are the reporting thresholds. Similar or different reporting thresholds could be used in the embodiment of FIGS. 20E-20F, which utilizes a set of ten ultrasound sensors.

In one embodiment, the ultrasound sensors 2002 will be configured to emit pulses sufficiently frequently to be able to detect or otherwise sense when a shopper removes a product item from the shelf 2020. This information may be integrated with that provided by, for example, a forward sensor 2050 (e.g., a camera), which may be configured to otherwise monitor a shopper positioned in front of the shelves 2010, 2020. The information received from the forward sensor 2050 and any other external sensors may be utilized in connection with the stock-out condition and shopper behavior information derived from the ultrasound sensors 2002. For example, in the event of the existence of a stock-out condition that cannot be immediately addressed (e.g., by re-stocking the shelf) and the detection of a customer proximate the applicable display unit 1901, the content displayed by the display unit 1901 may be refreshed to, for example, direct the customer to an alternate location in the store at which the product can be found or to recommend an alternate product.

When display units 1901 are deployed on retail shelving on both sides of an aisle of a retail establishment, the forward sensors 2050 forming part of or otherwise associated with display units 1901 on one side of the aisle may be used to monitor the stocking status of product items on the other side of the aisle. Specifically, when the forward sensors 2050 comprise cameras, images or video from the cameras may be evaluated to confirm that the product items located on shelving across the aisle from such cameras are the correct product items for the corresponding shelving locations. For example, such an evaluation could determine that a particular brand of cereal had not been stocked on its assigned shelf or portion thereof. In such event appropriate re-stocking could be performed by store personnel.

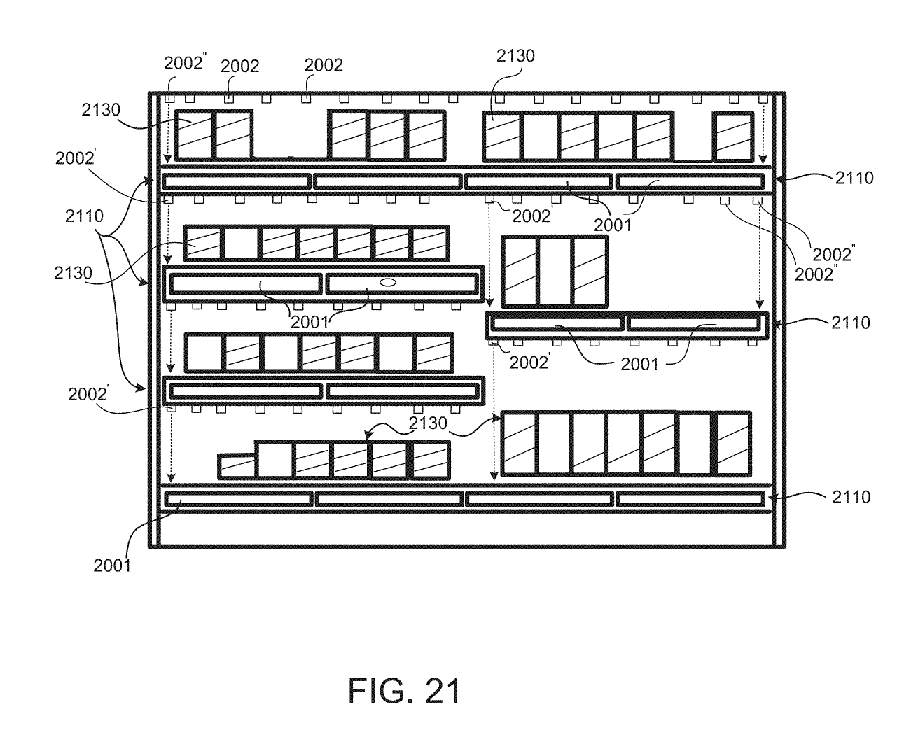

Attention is now directed to FIG. 21, which depicts an embodiment of a SOAR system in which one sensor within the group of ultrasound sensors 2002 associated with a particular portion of a retail shelf is utilized as a reference ultrasound sensor 2002′. In this embodiment each reference sensor 2002′ is positioned at a shelf location at which products 2130 are not placed when the shelf is stocked. For example, in the embodiment of FIG. 21, a number of the reference ultrasound sensors 2002′ are placed in reserved locations proximate ends of product shelves 2110 where product items 2130 are not stocked. In one embodiment such reserved areas could be marked or otherwise identified to ensure that product items 2130 are not placed within the reserved areas during the shelf stocking process. In the embodiment of FIG. 21 the reference ultrasound sensors 2002′ are configured with a narrow beam width such that the ultrasound emissions do not impinge upon product items 2130 near the sensors 2002′. The reference RTD determined using a given sensor 2002′ can be utilized by the display controller to evaluate the monitoring RTDs derived from ultrasound signals emitted by other sensors 2002 coupled to the same retail shelf. In one embodiment the sensors 2002 may be implemented using, for example, a MaxBotix EZ-1 Sonar Sensor.

Again referring to FIG. 21, there are illustrated examples of a stock-out condition as well as of various stock-out threshold conditions. For example, sensors 2002″ are seen to be positioned over a portion of shelf 2110″ lacking any product items 2130. As a consequence, the measured RTD associated with sensors 2002″ will be approximately the same as the reference RTD, which corresponds to a stock-out condition. Other sensors 2002 are positioned over portions of shelves 2110 having varying amounts of stacked products. In these areas the measured RTD associated with such sensors 2002 will be various percentages of the reference RTD. In one embodiment such percentages of the reference RTD (e.g., 20%, 40%, 60%, 80%, 100%) correspond to stock-out reporting thresholds which may be reported to external systems and/or used as the basis for informative messages conveyed by the display unit 1901 (e.g., messages directing shoppers to other areas in a retail store in which the applicable merchandise is stocked, or messages suggesting a substitute product).

In other embodiments the reference RTD is obtained by measuring the RTD between an ultrasound sensor 2002 and a portion of a shelf 2110 stocked with product items 2130. In this embodiment the monitoring RTDs recorded when monitoring pulses are sent by the sensors 2002 will increase beyond the reference RTD as product items 2130 are removed from the shelves 2110. In one embodiment an increase of a monitoring RTD beyond a predetermined percentage of the reference RTD results in an out-of-stock reporting threshold being exceeded and option reporting of this condition to an external system.

In other embodiments two reference RTDs may be utilized. Specifically, a first reference RTD may be established by measuring the RTD between an ultrasound sensor 2002 and a portion of a shelf 2110 stocked with product items 2130. The second reference RTD may be determined by recording the RTD between an ultrasound sensor 2002 and a shelf 2110 lacking any product items. This enables improved monitoring of stock levels of product items stacked on a retail shelf (e.g., boxes of cookies). For example, consider a case in which the first reference RTD is 20 ms and the second reference RTD is 220 ms. In this case a monitored RTD of 20 ms would correspond to a fully stocked condition, a monitored RTD of 120 ms would correspond to a 50% full/empty condition, and a monitored RTD of 220 ms would correspond to a completely empty condition. Stated differently, in the present case a monitored RTD of longer than 20 ms would indicate that at least some product items have been removed from the shelf and a monitored RTD of less than 220 ms would mean that product items remain on the shelf.

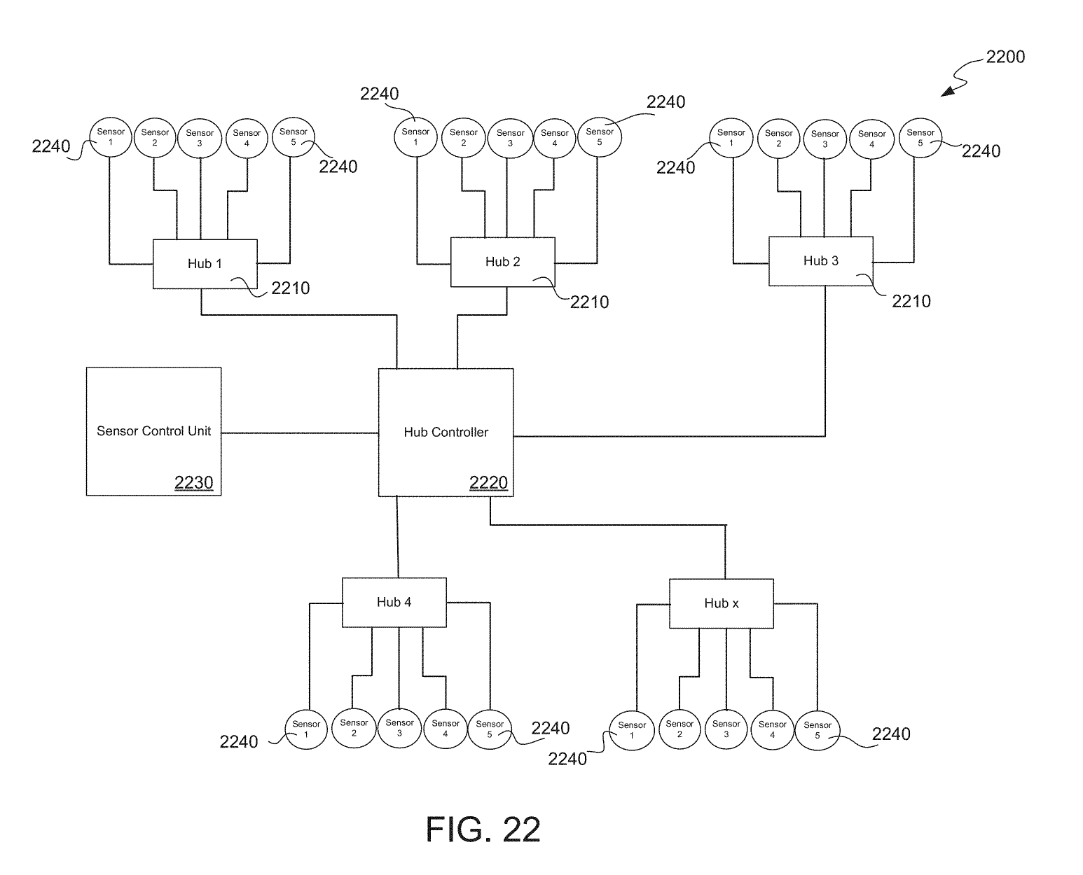

Attention is now directed to FIG. 22, which is a schematic diagram of a SOAR system 2200 capable of being deployed on multiple retail shelves (e.g., on multiple shelves of a gondola shelving unit). As shown, the system 2200 includes a plurality of hubs 2210 in signal communication with a hub controller 2220, which is in turn in signal communication with a sensor control unit 2230. A plurality of ultrasound sensors 2240 configured to be deployed on retail shelving in the manner described herein are communicatively coupled to each hub 2210.

Each hub 2210 effectively functions as a multiplexer configured to multiplex signal communications between the hub controller 2220 and the set of ultrasound sensors 2240 connected to the hub 2210. The hub controller 2220 controls signal routing between the sensor control unit 2230 and each hub 2210 and associated sensors 2240. The sensor control unit 2230 includes a processor configured to execute software for controlling the sensors 2240 and processing the signal information generated by the sensors 2240 in the manner described herein. In one embodiment the sensor control unit 2230 may be incorporated within a retail display unit (e.g., the display unit 1901 or 2001).

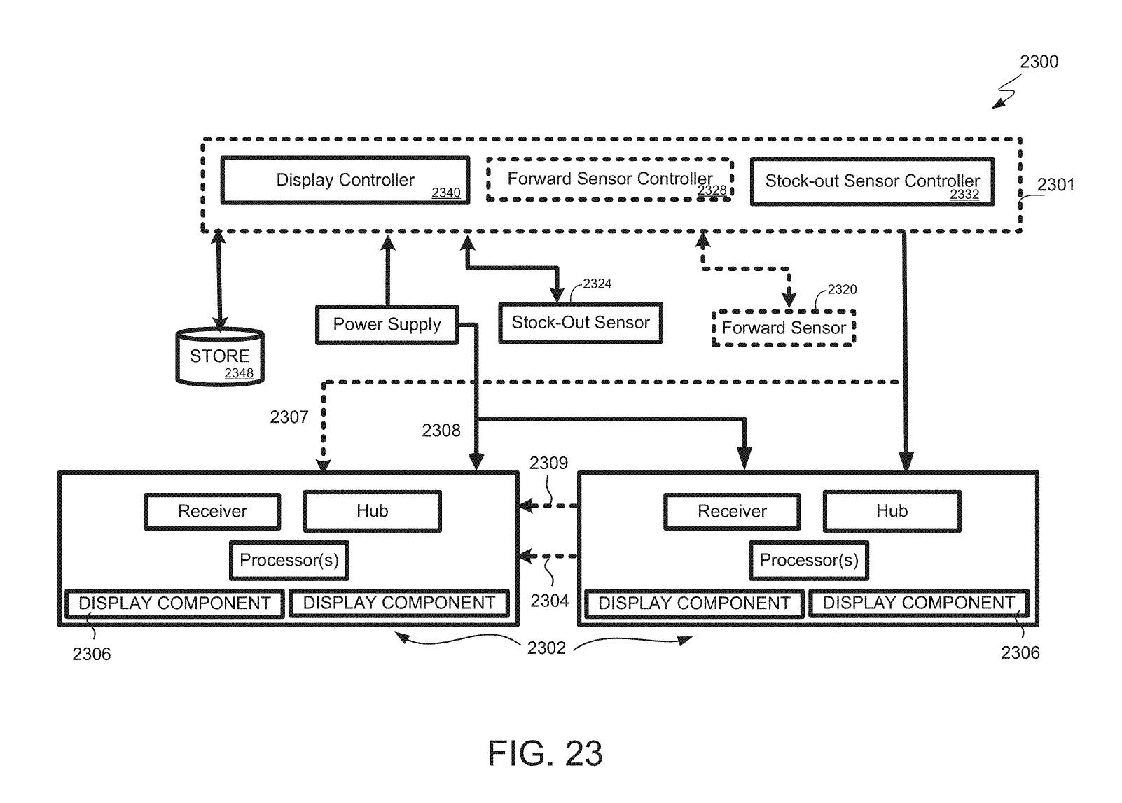

FIG. 23 illustrates an exemplary retail display and stock-out condition monitoring system 2300 comprising a controller 2301 and one or more display units 2302. A single controller is illustrated comprising a plurality of controller subunits combined to serve the function of the system controller. In some instances, a controller comprises one or more processors configured to execute one or more controller program modules. Exemplary program modules comprise, by way of non-limiting example, a sensor state identification module (e.g., configured to monitor or detect sensor states, including operating parameters thereof), a content identification module (e.g., configured to identify predetermined information to be provided to the one or more system display units based on the status of a sensor state), a content stitching module (e.g., configured to stitch the predetermined information (e.g., corresponding to local display information to ultimately be displayed at the display unit(s)) together, such as to form a global system display information, a content compression module (e.g., configured to compress display information), or combinations thereof. In some instances, a controller provided herein further comprises a transmitter configured to provide global system display information (e.g., compressed or not), to one or more system display units 2302. As illustrated, in some embodiments, a display unit (e.g., display strip) comprises a receiver configured to receive display information (e.g., global system display information or local display information). As further illustrated, in certain embodiments, a display unit (e.g., display strip) comprises one or more output (e.g., an output hub as illustrated) configured to provide display information (e.g., local display information) to one or more display components 2306 (two display components 2306 are illustrated, but units comprising a single or more than two display components 2306 are contemplated). In certain embodiments, a display unit provided herein comprises a receiver and an output (e.g., configured to provide display information to the display components). In some instances, the output is an output hub, as illustrated in FIG. 23, configured to provide display information to more than one display component of the display unit. In certain embodiments, a display unit provided herein further comprises one or more processor (e.g., FPGA) configured to execute program modules, such as any one or more of the various display unit program modules discussed herein. In certain embodiments, a display unit provided herein comprises an output configured to convey or transmit display information 2304 (e.g., global system display information) to another system display unit (e.g., by daisy-chaining). In other embodiments, a controller 2301 provided herein optionally provides display information (e.g., global system or local display information) directly 2307 to individual display units. In some embodiments, a system provided herein comprises one or more power supply 2350. In certain embodiments, the system comprises at least one power supply 2350 (e.g., a switching power supply configured to convert AC to DC, such as about 5 Vdc) configured to provide power to one or more display units and at least one power supply configured to provide power to the controller(s). In some instances, the system comprises one or more power supplies configured to provide power directly 2308 to one or more display units, configured to provide power directly to a first display unit and chained 2309 to a second display unit, or a combination thereof. In certain embodiments, the system 2300 further comprises one or more sensors, e.g., configured to provide sensor output signals (e.g., the sensor output signals conveying information regarding a sensor state—e.g., a state of an operating parameter) to the controller 2301. In specific instances, the controller 2301 comprises a display controller subunit 2340 configured to provide predetermined display information to one or more display units 2302 of the system. In some instances, the display controller 2340 provides display information to the one or more display units 2302 based on the sensor state of the system. In certain embodiments, the system comprises a forward sensor 2320 and a plurality of stock-out sensors 2324 configured to convey information to one or more sensor controllers, such as a forward sensor controller 2328 and/or stock-out sensor controller 2332 as illustrated in FIG. 23. In some instances, the sensor controller(s) comprise a module configured to determine the sensor state(s) (which is then optionally used by the display controller 2340 to determine the display information to convey to the one or more display units). In specific embodiments, the display controller 2340 is configured to retrieve display information from a data store 2348 based on the sensor state(s) identified by the sensor controller(s). In some embodiments, the display controller 2340 is configured to retrieve display information from the data store 2348 based on the sensor state(s) identified by the forward sensor controller 2328 (e.g., based on sensor information conveyed from one or more forward facing sensors 2320).

In certain embodiments, the stock-out sensor controller 2332 is configured to receive stock-out sensor signals from a stock-out hub controller (FIG. 22), which is in communication with the plurality of stock-out sensors 2324. As discussed above, the plurality of stock-out sensors 2324 may be arranged on the underside of an upper shelf extending over a lower shelf (not shown) to which the display units 2302 are mechanically coupled. The plurality of stock-out sensors 2324 may, for example, comprise a plurality of ultrasound sensors configured to identify one or more stock-out conditions with respect to product or merchandise located the lower shelf to which the display units 2302 are coupled.

In one embodiment the display controller 2301 may cause the display components 2306 of the display units 2302 to display predetermined information in response to sensor information received from the stock-out sensors 2324. For example, in the event of a stock-out condition the display components 2306 could be configured to, for example, display information indicating that the same or a similar product item is available on another aisle of the retail establishment.

In various embodiments, display units and systems described herein are configured to alter display content (e.g., alter display information provided to the display units) based on a sensor state of the display unit or system. In some instances, as discussed herein, such sensor states include identifying “motion” or “no motion.” In further embodiments, sensor states include (and/or a sensor, e.g., camera, provided herein is configured to be able to detect), by way of non-limiting embodiment, “motion,” “no motion,” and “captive” (e.g., as determined by identifying a face—i.e., facial recognition). Other exemplary sensor states include, by way of non-limiting example, “in proximity” or “not in proximity.” In some embodiments, exemplary sensor states (e.g., based on information received from a rear facing camera) include “item out of place,” “no item out of place,” “inventory low,” “inventory high,” and/or “inventory acceptable.” In certain embodiments, exemplary sensor states (e.g., based on information received from environmental sensors, such as temperature and/or humidity sensors) include, by way of non-limiting example, “temperature acceptable,” “temperature high,” “temperature low,” “humidity acceptable,” “humidity high,” and/or “humidity low.” Generally, based on such determinations, systems provided herein comprise program modules configured to identify and provide specific display information (content) to the display unit(s) thereof. For example, in some instances, when a sensor state is identified as “no motion” for one or more display unit, the system is configured to provide specific (and predetermined) display information, such as logos or decals of the products located at (e.g., on a shelf at, above, or below) the display units identified as having a sensor state of “no motion,” but when the sensor state is identified as “motion” for the one or more display unit, the system is configured to provide different, specific (and predetermined) display information, such as text describing the product(s), the price of the product(s), and optionally a QR code for the product(s) located at (e.g., on a shelf at, above, or below) the display unit(s) identified as having a sensor state of “motion.” In other exemplary embodiments, when a sensor state is identified as an environmental state being below or above acceptable levels, an inventory state being below an acceptable level, or an item is out of place, the system is configured to provide specific (and predetermined) display information, such as a type of alert—e.g., a generic alert—e.g., that there is an “unacceptable” sensor state, or a specific alert depending on the “unacceptable” state identified.

While various embodiments have been described above, it should be understood that they have been presented by way of example only, and not limitation. They are not intended to be exhaustive or to limit the claims to the precise forms disclosed. Indeed, many modifications and variations are possible in view of the above teachings. The embodiments were chosen and described in order to best explain the principles of the described systems and methods and their practical applications, they thereby enable others skilled in the art to best utilize the described systems and methods and various embodiments with various modifications as are suited to the particular use contemplated.

Where methods described above indicate certain events occurring in certain order, the ordering of certain events may be modified. Additionally, certain of the events may be performed concurrently in a parallel process when possible, as well as performed sequentially as described above. Although various modules in the different devices are shown to be located in the processors of the device, they can also be located/stored in the memory of the device (e.g., software modules) and can be accessed and executed by the processors. Accordingly, the specification is intended to embrace all such modifications and variations of the disclosed embodiments that fall within the spirit and scope of the appended claims.

The foregoing description, for purposes of explanation, used specific nomenclature to provide a thorough understanding of the claimed systems and methods. However, it will be apparent to one skilled in the art that specific details are not required in order to practice the systems and methods described herein. Thus, the foregoing descriptions of specific embodiments of the described systems and methods are presented for purposes of illustration and description. They are not intended to be exhaustive or to limit the claims to the precise forms disclosed; obviously, many modifications and variations are possible in view of the above teachings. The embodiments were chosen and described in order to best explain the principles of the described systems and methods and their practical applications, they thereby enable others skilled in the art to best utilize the described systems and methods and various embodiments with various modifications as are suited to the particular use contemplated. It is intended that the following claims and their equivalents define the scope of the systems and methods described herein.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded into one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for stock-out detection in a retail environment, the method comprising:
sending, from a reference ultrasound emitter, a reference ultrasound pulse that is at least partially reflected by a retail shelf so as to form a return pulse;
receiving, at a reference ultrasound receiver, the return pulse and determining a reference round-trip-delay (RTD) corresponding to a time period between the sending of the reference pulse and the receiving of the return pulse;
sending a monitoring ultrasound pulse toward the retail shelf and receiving a reflection of the monitoring ultrasound pulse; and
determining a stock-out condition based upon a comparison of the reference RTD and a monitored RTD associated with the monitoring ultrasound pulse.

2. The method of claim 1 further including positioning the reference ultrasound emitter such that the reference ultrasound pulse is reflected by a reference portion of the retail shelf lacking any product items.

3. The method of claim 1 wherein the sending the sending of the reference ultrasound pulse occurs when product items are not present upon the retail shelf.

4. The method of claim 1 wherein the determining includes determining the monitored RTD is approximately equivalent to the reference RTD.

5. The method of claim 1 wherein the determining includes determining the monitored RTD is greater than a predetermined percentage of the reference RTD, the predetermined percentage corresponding to a stock-out reporting threshold.

6. The method of claim 1 further including:
periodically sending a plurality of monitoring ultrasound pulses from a plurality of locations above the retail shelf;
periodically determining a plurality of monitored RTDs associated with the plurality of monitoring ultrasound pulses;
determining an additional stock-out condition based comparison of ones of the plurality of monitored RTDs with the reference RTD.

7. The method of claim 1 further including:
sending a plurality of monitoring ultrasound pulses wherein time intervals between ones of the plurality of monitoring pulses are selected based upon an anticipated time required for a shopper to remove a product item from the retail shelf;
detecting removal of one or more product items from the retail shelf by comparing an RTD of at least one of the plurality of monitoring pulses to the reference RTD.

8. A retail display and stock-out detection system, the system comprising:
a. a display unit, the display unit comprising a viewable display surface attached to a retail shelving assembly;
b. an ultrasound emitter/receiver pair, the ultrasound emitter/receiver pair being configured to emit ultrasound signals toward a shelf of the retail shelving assembly and to receive reflections of the ultrasound signals;
c. a controller unit in communication with the display unit and the ultrasound emitter/receiver pair, the ultrasound emitter/receiver pair being further configured to provide an output signal to the controller unit wherein the output signal conveys round-trip-delay (RTD) information associated with the emitted ultrasound signals and the received reflections, the sensor controller comprising:
an input configured to receive the output signal; and
one or more processors configured to execute controller program modules, the controller program modules comprising:
one or more modules configured to determine a monitored RTD associated with one or more of the ultrasound signals;
one or more modules configured to determine a stock-out condition based upon a comparison of a reference RTD and the monitored RTD.

9. The system of claim 8 wherein the controller unit is configured to change information displayed by the retail display unit in response to determination of the stock-out condition.

10. The system of claim 8 wherein the ultrasound emitter/receiver pair is configured to emit a reference ultrasound signal toward a reference portion of the shelf lacking any product items and to receive a reflection of the reference ultrasound signal, the controller program modules including a module configured to determine the reference RTD based upon a time difference between emission of the reference ultrasound signal and reception of the reflection of the reference ultrasound signal.

11. The system of claim 8 further including a reference ultrasound emitter/receiver pair configured to emit a reference ultrasound signal toward a reference portion of the shelf lacking any product items and to receive a reflection of the reference ultrasound signal, the controller program modules including a module configured to determine the reference RTD based upon a time difference between emission of the reference ultrasound signal and reception of the reflection of the reference ultrasound signals.

12. The system of claim 8 wherein the one or more modules configured to determine a stock-out condition are further configured to determine the stock-out condition exists when the monitored RTD is approximately equivalent to the reference RTD.

13. The system of claim 8 wherein the one or more modules configured to determine a stock-out condition are further configured to determine the monitored RTD is greater than a predetermined percentage of the reference RTD, the predetermined percentage corresponding to a stock-out reporting threshold.

14. The system of claim 8 further including a plurality of ultrasound emitter/receiver pairs arranged along a surface above the shelf of the retail shelving assembly, each of the plurality of ultrasound emitter/receiver pairs being configured to periodically send a monitoring ultrasound pulse.

15. The system of claim 14 wherein the surface corresponds to the underside of another retail shelf of the retail shelving unit located above the shelf.

16. The system of claim 8 further including a camera oriented in a direction substantially the same as an axis intersecting the viewable display surface, the camera being configured to capture at least one of images and video of shoppers proximate the display unit.

17. The system of claim 8 wherein the ultrasound emitter/receiver pair is configured to emit a reference ultrasound signal toward that is at least partially reflected by one or more product items on the retail shelf so as to form a reflection of the reference ultrasound signal received by the ultrasound emitter/receiver pair, the controller program modules including a module configured to determine the reference RTD based upon a time difference between emission of the reference ultrasound signal and reception of the reflection of the reference ultrasound signal.

18. The system of claim 17 wherein the one or more modules configured to determine a stock-out condition are further configured to determine the stock-out condition exists when the monitored RTD is greater than the reference RTD.

19. The system of claim 17 wherein the one or more modules configured to determine a stock-out condition are further configured to determine the monitored RTD exceeds the reference RTD by a predetermined percentage, the predetermined percentage corresponding to a stock-out reporting threshold.

20. A method for stock-out detection in a retail environment, the method comprising:
sending, from a reference ultrasound emitter, a reference ultrasound pulse that is at least partially reflected by one or more product items on a retail shelf, thereby forming a return pulse;
receiving, at a reference ultrasound receiver, the return pulse and determining a reference round-trip-delay (RTD) corresponding to a time period between the sending of the reference pulse and the receiving of the return pulse;
sending a monitoring ultrasound pulse toward the retail shelf and receiving a reflection of the monitoring ultrasound pulse; and
determining a stock-out condition based upon a comparison of the reference RTD and a monitored RTD associated with the monitoring ultrasound pulse.

21. The method of claim 20 wherein the determining includes determining the monitored RTD is greater than the reference RTD.

22. The method of claim 20 wherein the determining includes determining the monitored RTD exceeds the reference RTD by a predetermined percentage, the predetermined percentage corresponding to a stock-out reporting threshold.
